(19) United States
(12) Patent Application Publication
(10) Pub. No.: US 2004/0039916 A1
(43) Pub. Date: Feb. 26, 2004

(54) System and method for multi-tiered license management and distribution using networked clearinghouses

(76) Inventors: David Aldis, Surrey (CA); Brian Kejser, Vancouver (CA); Innes Muecke, Nova Scolia (CA); Heinrich Henning Riebe, Vancouver (CA)

Correspondence Address: Stacey J. Longanecker, Roylance, Abrams, Berdo & Goodman, L.L.P., Suite 600, 1300 19th Street, N.W., Washington, DC, 20036, US

(21) Appl. No.: 10/434,355

(22) Filed: May 9, 2003

Related U.S. Application Data
(60) Provisional application No. 60/379,105, filed on May 10, 2002.

(51) Int. Cl. H04L 9/00

(52) U.S. Cl. 713/177; 705/59

(57) ABSTRACT

A system and method are provided for the distribution of digital licenses through a multi-level distribution chain using one or more clearinghouses. The system supports content providers, distributors, and end users. Content providers create and provide licenses. Distributors acquire licenses from content providers and upstream distributors, and can modify them in accordance with the terms of the original licenses. Distributors digitally sign modified licenses before providing to other users. Distributors optionally extend licenses to create new licenses and distribute them. End users acquire, download and activate licenses. Content providers and distributors can obtain tracking reports from clearinghouses detailing transactions (e.g., purchases, acquisitions, activations, and license compliance) associated with licenses as they progress down the distribution chain and are finally activated.

This application claims the benefit of U.S. provisional application Serial No. 60/379,105, filed May 10, 2002.

### CROSS REFERENCE TO RELATED APPLICATIONS

Related subject matter is disclosed and claimed in co-pending U.S. patent application Ser. No. 10/126,973, filed by Shannon Byrne et al on Apr. 22, 2002; in co-pending U.S. patent application Ser. No. 10/126,974, filed by Shannon Byrne et al on Apr. 22, 2002; and in U.S. patent application Ser. No. 10/334,139, filed by Henning Riebe et al on Dec. 31, 2002; all of said applications being expressly incorporated herein by reference.

### FIELD OF THE INVENTION

The invention relates to the licensing of multimedia content and software. More particularly, the invention relates to a system and method using one or more clearinghouses to proactively facilitate licensing of digital content and/or software between content providers, upstream and downstream distributors, and end users, and providing reports and other support to users of the system and method as needed.

### BACKGROUND OF THE INVENTION

Most legitimate computer software use is regulated through the use of software licenses. Licenses are particularly prevalent in the software industry for a number of reasons related to the nature of the industry and product. Unlike tangible objects, software may be possessed and used without any outward indication of such possession. Software can easily be transferred from one computer to another, without much indication, if any, that a transfer has taken place. Further, since software or other content exists as a “copy” in memory associated with a computer, the original owner may retain this “copy” and still sell “use” of the floppy or CD-ROM that holds the software or other content to another, resulting in substantial losses in revenue and profits for the publisher of the software product or digital content provider.

Accordingly, software providers retain control of the transfer of their product by licensing the product for use by the original end user. As is well known, a license may be thought of as bundle of rights that define the privileges of possession enjoyed by the end user of the product. For example, these rights can specify the number of authorized copies a user can make, whether the licensed product is restricted to use in certain specific locations or subject to unrestricted use, which person(s) are authorized to use the product, and how many times the product may be used. Software providers retain the rights that are considered vital such as the right of transfer. The right to transfer a licensed software product is either not bestowed, or is dependent upon conditions that must be fulfilled by the original owner such as registration of the new owner and certification that the copy maintained on the original owner's computer has been destroyed. The true power of the software license rests in its deterrent effect. Laws have been enacted that provide stiff penalties, possible imprisonment, or both, if license provisions regarding the transfer of software products are violated.

There are many different types of licenses, each of which reflects the intended use of the software. Until recently, a software license was merely printed license statement included in a product's packaging. Software vendors therefore relied on the integrity of their customers to not violate the license terms. In many cases, this was sufficient to protect the vendors' investment in developing the software. More specifically, printed licenses provided inside packaged software products included an End User License Agreement (EULA). With an EULA, it is assumed that the user has agreed to the terms of the license and is legally bound to the agreement once they have purchased and opened the software package. Many software manufacturers or providers plainly state that, through use of the product, an implicit understanding and agreement of the terms of the license is made. Accordingly, the software itself often does not contain methods to enforce the terms of the license. At most, software installation required a serial number provided on or within the software packaging to thwart casual piracy. In other words, the software cannot be installed without the serial number and therefore without the original packaging. However, the serial number can be easily copied and posted on web sites, news groups, and bulletin boards for other users to use with a pirated version of the software. Further, it is not possible for a publisher to know when and where the software is actually being used, except through a costly and alienating audit process. Thus, while a licensing agreement has effectively been accepted, the licensee is completely anonymous to the licensor.

Another type of license is an “online” license, which is used for content and software that is made available for downloading from the Internet. These types of licenses are commonly used for “shareware” or “trialware” that is available to download for free. Before downloading or installing the software, the user is typically requested to read an EULA on the screen and click on a button to accept or deny the terms in lieu of a signed agreement. It is presumed that the reader has read and understood the entire agreement and has agreed to it so as to be legally bound by the terms.

Another type of license is a site license. A large organization can purchase a single license from a software vendor or distributor that allows a software application to be installed on an allowable number of computers per an agreement. A single site license can assist an organization in keeping track of their licenses for purchased software, since they only have to track the number of installations of the application and not the individual licenses for each installation. Multiple installations can then be made from a single source such as a CD-ROM, rather than requiring a source disc for each installation site.

More recently, digital licenses that contain enforcement information have been introduced. A digital license contains usage terms and metadata, as well as encrypted and digitally signed information that is used in conjunction with license enforcement software to ensure that the usage of the software/content is within the license terms. Metadata refers to information in the digital license that is used to describe the restrictions on how the license terms can be modified by downstream users such as a distributor or an end user. For example, a restriction may state that a license is valid for 60 days and that this term cannot be changed by anyone except distributor A, who can extend it to between 61 days and 90 days. This new type of license often requires the user to enter a code in order to activate the license.

Sometimes, a license management system is in place for content providers to collect user registration information and provide activation codes for the digital licenses via the distribution channel. More advanced license registration systems or digital information distribution systems tie the activation codes to the user's computer (e.g., using product codes that are computer-dependent by being based on the hardware fingerprint of the computer requesting the activation code) so that the activation codes cannot be used on other unauthorized computers, as described in commonly-assigned U.S. Pat. No. 5,809,145, which is incorporated herein by reference in its entirety for all purposes. License registration systems can also help an organization track its internal usage of licenses for bookkeeping and auditing purposes.

The ability to create these digital licenses, and the desire to track their use, manage commerce transactions, provide customer support, track assets, and so on, has, in turn, created increasing demand for more comprehensive license transaction systems. Therefore, as licensing complexity increases for software and digital content, there exists a need for a new system for license management and distribution which supports flexible distribution models (e.g., multi-tier, software or content demand chains that can be defined by a content provider), manages end user registration, and tracks the use of licenses for auditing and bookkeeping purposes.

### SUMMARY OF THE INVENTION

It is therefore an object of the invention to provide a system and method for license management and distribution which supports flexible distribution models, and manages license transaction, registration and activation, as well as payment and commerce transactions, as appropriate. Additionally, tracking of the use of licenses is performed for auditing and bookkeeping purposes. Auditing and bookkeeping functions can also be performed for all of the aforementioned activities.

The present invention provides a system and method for digital content providers or software publishers to maintain control over the licenses for their content as it moves through the distribution network to the end user. In this system, content providers and distributors are able to track where their licenses are, who is using them, and when license abuse is taking place. The system of the present invention promotes or requires user registration without placing a heavy burden on the user. Also, content providers and distributors are able to track their licenses for auditing and bookkeeping purposes through usage reports generated by the clearinghouse.

In accordance with an aspect of the present invention, a system and method are provided for creating one or more clearinghouses to proactively facilitate licensing of digital content and/or software between content providers, upstream and downstream distributors, and end users, and providing reports and other support to users of the system and method as needed. For example, the system and method provide for transmission of digital licenses from the owner of the software or content to, typically, an enterprise or end user.

In accordance with an aspect of the present invention, a system and method are provided to facilitate migration of digital licenses through distribution channels and allow additional rights and/or restrictions to be incorporated in them. A provider can track the distribution of products through various channels to the user. The channel types include, but are not limited to, direct, distributor/dealer/reseller, OEM, VAR and large volume reseller (LVR). In addition to billing and reconciliation of the different channel partners, the provider can obtain accurate and real-time statistical and performance data from a clearinghouse in the license distribution system.

While systems exist (e.g., GLOBEtrotter™) which track license use, the present invention provides the ability to conduct and track license transactions and activations (i.e., user transactions), along with registrations, payment and commerce transactions, and so on, as appropriate. Content and software does not have to always accompany the license, but may incorporate part of the locking/unlocking mechanism.

These aspects and objects of the invention are provided by a method for distribution of licenses in a network, comprising the steps of creating a license in a license distribution network, offering the license for acquisition, acquisition or transferal via the license distribution network, optionally selling and otherwise providing the license through the license distribution network to a end user, bundling the license in the license distribution network, downloading the license to the end user, validating the license with the license clearinghouse and activating the license to be used by the end user.

Furthermore, the objects of the invention are provided by a system for the sale, acquisition and distribution of licenses in a network, comprising at least one license clearinghouse, at least one content provider, at least one end user, and wherein the license clearinghouse, content provider, and end user are interconnected by the network. Optionally, at least one payment processor and/or distributor can also be provided in the system.

Distributors and content providers can download license packs to distribute with the content or software on CD-ROM. A License pack ID is generated when the pack is assembled just prior to downloading. License packs can be entirely encrypted with one key (i.e., requires one activation code for the entire license pack), or each license in the pack can be encrypted with a unique key (i.e., requires an activation code for each license). The activation code contains a key to decrypt the license pack. License package is then signed.

License activation flexibility (e.g., license tolerance) is provided. A license can be activated for a fixed number of times before activation is refused. The number of allowed activations and the number of registered activations are stored in the clearinghouse database. The allowed number of activations, and any allowed changes in the number of activations are listed as terms in the license. These values can be modified by downstream distributors if the license terms allow them to.

Content provider functions include, but are not limited to: (1) log on to the clearinghouse and create new licenses for a product; (2) specify the terms of a licenses; (3) digitally sign the license; (4) encrypt the license to place it in a pre-activated state; (5) make selected licenses available for acquisition to other selected distributors and end users; (6) download license packs from their inventory for distribution on physical media such as CD-ROM; and (7) request reports on license inventory status, license acquisitions, and downstream activity of licenses.

Distributor functions include, but are not limited to: (1) log on to the clearinghouse and browse licenses available for acquisition from content providers and other upstream distributors; (2) transfer selected licenses to the distributor's inventory after optional payment transactions and contract negotiations are complete; (3) if the original license allows modification of specific terms in a set of licenses, then modify them or add new terms as long as they do not conflict with the original license; (4) digitally sign the license containing original license and the modified terms; (5) make selected licenses available for acquisition to other selected distributors and end users; (6) download license packs from their inventory for distribution on physical media such as CD-ROM; and (7) request reports on license inventory status, license acquisitions, and downstream activity of licenses.

End User functions include, but are not limited to: (1) log on to the clearinghouse, and optionally register; (2) download license pack if it was not included with the content distribution; (3) if the licenses are in a pre-activated state, get activation code from clearinghouse by supplying a license pack ID, installation code, and optional payment info (via secure connection, telephone, or facsimile); (4) enter the activation code to activate the license on the users system, which allows them to use the content; and (5) whenever the content or software is used, license compliance software on the end users computer may optionally communicate with the clearinghouse to ensure license compliance.

### BRIEF DESCRIPTION OF THE DRAWINGS

The present invention will be best understood by reference to the detailed description of the preferred embodiments which follows, when read in conjunction with the accompanying drawings, in which:

FIG. 1 illustrates a digital license distribution system in accordance with an embodiment of the present invention;

FIG. 2 illustrates a license clearinghouse used in a digital license distribution system in accordance with an embodiment of the present invention;

FIG. 3 illustrates a content provider and a license clearinghouse in a digital license distribution system in accordance with an embodiment of the present invention;

FIG. 4 illustrates a distributor and a license clearinghouse in a digital license distribution system in accordance with an embodiment of the present invention;

FIG. 5 illustrates an end user and a license clearinghouse in a digital license distribution system in accordance with an embodiment of the present invention;

FIG. 6 illustrates a service relationship between two license clearinghouses in a digital license distribution system in accordance with an embodiment of the invention;

FIG. 7 illustrates a service relationship between a license clearinghouse and a third-party processor in a digital license distribution system in accordance with an embodiment of the present invention;

FIG. 8 illustrates the structure of a digital license created by a content provider in accordance with an embodiment of the present invention;

FIG. 9 illustrates the structure of an extended digital license created by a distributor in accordance with an embodiment of the present invention;

FIG. 10 illustrates the structure of a digital license pack created by a content provider in accordance with an embodiment of the present invention;

FIG. 11 is a flow diagram that illustrates creating a digital license or an renewal/upgrade digital license by a content provider in accordance with an embodiment of the present invention;

FIG. 12 is a flow diagram illustrating a method for creating an extended digital license or an extended renewal/upgrade digital license by a distributor in accordance with an embodiment of the invention;

FIG. 13 is a flow diagram illustrating how a content provider provides a plurality of license types to an end user in accordance with an embodiment of the present invention;

FIG. 14 is a flow diagram illustrating how a content provider provides a plurality of license types to a distributor in accordance with an embodiment of the present invention;

FIG. 15 is a flow diagram illustrating how a first distributor provides a plurality of license types to a second distributor in accordance with an embodiment of the present invention;

FIG. 16 is a flow diagram illustrating a distributor providing a plurality of licenses to an end user in accordance with an embodiment of the present invention;

FIG. 17 is a flow diagram illustrating the transfer of ownership of an upgrade or renewal license from a content provider or distributor to an end user in accordance With an embodiment of the present invention;

FIG. 18 illustrates a first example of an activation and authentication process in accordance with an embodiment of the present invention;

FIG. 19 illustrates a second example of an activation and authentication process in accordance with an embodiment of the present invention;

FIG. 20 illustrates the structure of a renewal/upgrade digital license created by a content provider in accordance with an embodiment of the present invention;

FIG. 21 illustrates the structure of a renewal/upgrade digital license pack created by a content provider in accordance with an embodiment of the present invention;

FIG. 22 illustrates the structure of an extended digital license pack created by a distributor in accordance with an embodiment of the present invention;

FIG. 23 illustrates the structure an extended renewal/upgrade digital license created by a distributor in accordance with an embodiment of the present invention;

FIG. 24 illustrates the structure of an extended renewal/upgrade digital license pack created by a distributor in accordance with an embodiment of the present invention;

FIG. 25 is a flow diagram illustrating the creation of a digital license pack or a renewal/upgrade digital license pack by a content provider in accordance with an embodiment of the present invention; and

FIG. 26 is a flow diagram illustrating the creation of an extended digital license pack or extended renewal/upgrade digital license pack by a distributor in accordance with an embodiment of the present invention.

The various features of the preferred embodiments will now be described with reference to the figures, in which like parts are identified with the same reference characters.

### DETAILED DESCRIPTION OF THE PREFERRED EMBODIMENTS

The present invention relates to a system and method of distributing and managing digital licenses for software and multimedia digital content over a network such as the Internet.

1. System Overview

There can be many possible distribution paths that licenses for content (e.g., multimedia content or software) can take from a content provider to an end user. For example, a license for content can be distributed via a direct path, that is, the end user gets the license for content directly from the content provider. This is exemplified by small software publishers or other content providers who post their licenses for content on the Internet to make them available for download directly to the end users. For other types of licenses, distributors can acquire licenses from the content provider for distribution. Different distribution channels are also available for the content itself. One such distribution path is exemplified by websites that make available for acquisition such content as music, research and reference information, software from medium and large publishers, or digital movies from other content sources. The license distribution system and method of the present invention is capable of supporting a variety of content distribution models.

Additionally, it is to be noted that the term “license” shall be used in describing the system and method of the invention. It is to be understood that the term “license” is used generically to include a simple software license, digital license, site license, online license, and so on. In other words, the term “license” means any type of license capable of being transferred via any type of communication means, including, but not limited to, the Internet, wireless Internet, Intranets, LANs, WANs and any other type of communication path that connects two or more devices capable of receiving and using licensed products.

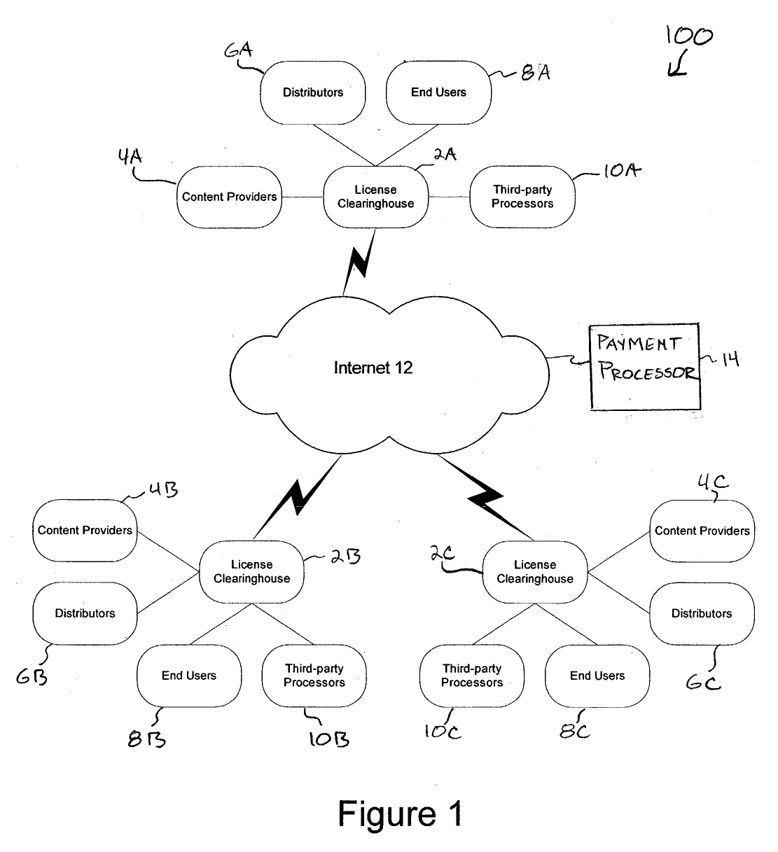

FIG. 1 illustrates a digital license distribution system (LDS) 100 in accordance with an embodiment of the present invention. The system 100 can comprise five possible network entities: license clearinghouses 2A-C, content providers 4A-C, distributors 6A-C, end users 8A-C, and third-party processors 10A-C. License clearinghouses 2A-C have the ability to connect to one another through a network such as the Internet 12. There can be many license clearinghouses 2 in digital license distribution system 100. Each license clearinghouse 2 can also be connected to at least one other license clearinghouse 2 in the system. Alternatively, digital license distribution system 100 can also exist with only a single license clearinghouse 2.

Multiple content providers 4, distributors 6, end users 8, and third-party processors 10 (e.g., payment processors and ERP integration) also have the ability to connect to a license clearinghouse 2 through a digital network such as the Internet 12. There is at least one content provider 4 connected to at least one license clearinghouse 2 in the digital license distribution system 100, because preferably only content providers 4 are able to create new licenses.

2. License Clearinghouse

In accordance with an embodiment of the present invention, the license distribution system 100 comprises a distributed network of license clearinghouses 2. The clearinghouses 2 store digital license information and manage the distribution of the licenses from the content provider 4 down the distribution chain to the end user 8. Connected clearinghouses 2 can share license inventory information and therefore share users. For example, users of clearinghouse A can potentially (i.e., as allowed and desired) browse the license inventory on clearinghouse B without having to register and connect directly to clearinghouse B.

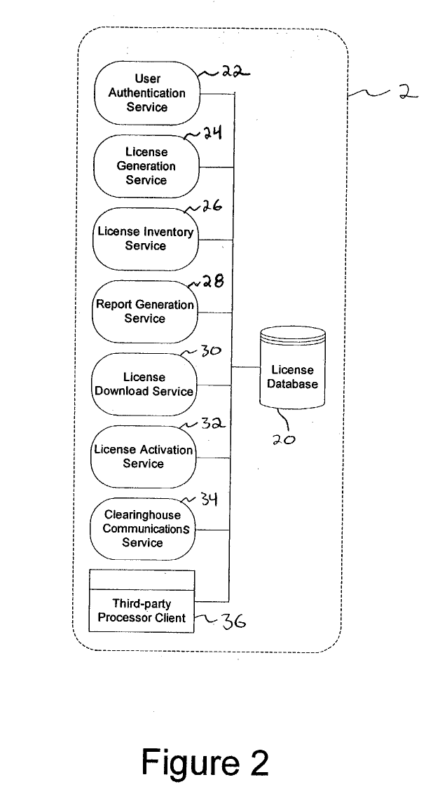

More specifically, the clearinghouse 2 comprises a master license database 20 (FIG. 2), as well as a set of modules that provide an interface for the system users, enabling them to perform tasks such as license creation, downloading, and activation. The clearinghouse 2 also communicates with optional external payment processors 14. The payment processors 14 handle payment transactions between users in the system 100. Each payment processor may handle a particular type of payment method, such as credit cards or pre-paid digital cash.

Each clearinghouse 2 therefore comprises an inventory 20 of licenses that it manages on behalf of its users. Multiple clearinghouses 2 can connect together to share their license inventory, allowing users to browse and purchase or otherwise acquire licenses from other clearinghouses 2 in the network. Alternatively, the present invention can be implemented with only a single clearinghouse. A clearinghouse can bundle licenses into packages that are compatible with third-party license servers (i.e. Microsoft License Server) or license compliance software so that the licenses can be integrated with third-party software products and content.

The users that use the clearinghouse services are content providers, distributors, and end users. Each type of user will now be described.

Content providers 4 are generally entities that have something (e.g., digital content or software) to provide others and generally do not acquire content or software. Some examples of content providers are software publishers and digital media sources. Content providers 4 create new digital content and provide it to distributors 6 and end users 8. In the disclosed embodiment, content providers are generally only interested in licensing and providing (which can include selling) their content. They are not interested in purchasing existing licensed content. It is to be understood, however, that the license distribution system 100 can support content providers 4 that do one, the other, or both, along with distributors 6 that acquire and provide licenses, and affiliates that are just referenced and managed in the license transaction process (presumably for a commission upon their referral). In addition, a company that uses the system 100 can act as more than one entity in the system. For example, a company can be a content provider 4 for some products, a distributor 6 of other bundled products, and an end user 8 of third party products. Also, a company may contain multiple entities of the same type such as for different divisions or product lines. The entities that a company uses are dependent upon the structure of each individual company.

Distributors 6 in this system are interested preferably only in buying or acquiring, modifying, and providing or selling licenses for existing content. They preferably do not provide any new content. The distributor 6 is allowed to modify licenses by adding terms and metadata, or combine two or more existing licenses that they have purchased or otherwise acquired into a new license. Distributors 6 cannot modify the terms of the original license that was created by the content provider 4. This is verified by the content provider 4 digitally signing the original terms so that no one can tamper with the terms as the license moves down the distribution channel. Distributors 6 can add whatever terms they want as between a content provider 4 and a distributor 6, but the modified license will contain a copy of the untamperable original license, so that changes will be documented. The system 100 preferably does not allow a content provider or a distributor to provide or sell a license that they have not digitally signed, respectively. Distributors 6 then resell or otherwise provide the modified licenses to end users 8 and other downstream distributors 6. Examples of distributors include software resellers, and content re-packagers or bundlers.

End users 8 are preferably only interested in acquiring one or more licenses, which can but need not necessitate purchasing the licenses, and activating the licenses. End users 8 can be individuals or companies and other organizations that purchase or acquire content for multiple internal users. In the illustrated embodiment, the end user has one or more computing devices that are capable of storing a digital license (such as a computer, set-top box, game console, or audio player). In accordance with other embodiments of the present invention, an ASP-type or other web-based service can be used for license storage. For example, a license can be stored on a mainframe and the content or software associated with the license can be licensed only for use on a particular terminal. In other words, the user can acquire a license, but the license itself may be delivered to a storage device that is not directly connected to the computing device of the user 8.

As will be described in more detail below, the license clearinghouse 2 provides license management services such as license generation, tracking/compliance, reporting, and payment functions that allow content providers and distributors to control the distribution of digital licenses to other distributors or end users. These management services are provided through a management interface that consists of a set of interface modules (FIG. 2) at the clearinghouse 2. Users interact with the clearinghouse modules using a license management interface. The license management interface, which is hereinafter referred to as the license management client, can be in the form of a local application that the user installs on his computer (e.g., a license Application Programming Interface (API)), or an administrative web site at the clearinghouse that allows the users to manage their licenses through a web browser. The clearinghouse uses external payment processors 14 (FIG. 1) to handle various types of payment transactions that occur between users. As stated above, multiple payment processors may be used to handle various payment methods. For example, one external payment processor may handle credit card transactions and another processor may handle digital cash, Electronic Data Interchange (EDI) transactions, or other types of business data transactions.

The present invention provides a method for content providers 4 to maintain control over the licenses for their content as the licenses move through the distribution network to the end user 8. In this system 100, content providers 4 and distributors 6 are able to track where their licenses are, who is using them, and when license abuse is taking place. It promotes or requires user registration without placing a heavy burden on the user 8. Also, content providers 4 and distributors 6 are able to track their licenses for auditing and bookkeeping purposes through usage reports generated by the clearinghouse. The digital license distribution system 100 preferably manages and distributes digital licenses and not content created by the content providers. Content is distributed via a separate system such as downloading from Internet web sites or distribution on a CD-ROM, DVD or other storage device through conventional distribution channels.

Content providers 4 can create digital licenses through the license management interface or client. They can specify the terms of the license, the number of licenses in a license pack, and the number of license packs they wish to create. Licenses are then digitally signed using the content provider's certificate and the signatures are stored in the database 20 (FIG. 2).

Distributors can modify licenses in their inventory in the database 20 by adding new terms, but they preferably cannot change the terms of the original license. The modified license consists of the original license and the new terms. It is then signed using the distributor's certificate and the signature is added to the database 20. Another modification that distributors can make is to combine two or more original licenses that they have purchased or acquired into a new license that contains the original license, as well as new terms. The new license is signed by the distributor 6 and stored in the database 20 (FIG. 2).

Digital licenses can be distributed in the form of license packs. A license pack contains one or more digital licenses. For example, a license pack may be required if the license involves special terms differing from other licenses (e.g. some features turned on), or if it involves multiple user licenses or site licenses. A digital license is essentially a license identifier, which may be represented as a unique string of numbers, along with license terms. A license pack contains a set these unique numbers that identify each individual license. If the terms are the same for all of the licenses in the pack (i.e., an enterprise site license for several installations), then the terms only have to be stated once and included with the set of identifiers for the individual licenses. As individual licenses are extracted from the pack, the terms are then added back into it to create a complete digital license.

The end users 8 can download the licenses from the clearinghouse 2. When the end user 8 requests a download, the license bundling function of the clearinghouse 2 locates the license information in the database 20, generates a downloadable license package, and optionally encrypts it and signs it with the user's public key. After the user downloads the license package, he verifies the clearinghouse signature, decrypts the package with his private key, and installs the licenses on his system or in a license server. As described in further detail below, activation of a multi-license pack can be accomplished with a single activation code.

One way to manage end user license distribution is to require end users 8 to register their licenses, in accordance with an aspect of the present invention. End users can be required to register their licenses to use the software/content, which is protected by license compliance software or hardware. The compliance software may be attached to the software/content, or may be integrated into the operation system or hardware of the computer. The user can access the content after registration by entering an activation code that is supplied by the registration system. As described in more detail below, an activation code can be created that is specific to the user, which prevents unauthorized use activation codes by other users.

Since all of the license tracking and registration information is preferably stored in a central database 20 at the clearinghouse 2, the information can be used to generate tracking and usage reports for the users. All of the users in the distribution chain are clearinghouse users, so the movement of the licenses down the distribution chain can also be tracked. Users in the distribution chain have the ability to track the movement of the licenses that they have sold downstream to the end user. This tracking information can be restricted by upstream users in the chain.

FIG. 2 illustrates the logical structure of a license clearinghouse 2 used in the digital license distribution system 100 in accordance with an embodiment of the invention. License clearinghouse 2 comprises license database 20, which stores information relating to licenses, as well as account information for users of license clearinghouse 2. License database 20 is connected to a set of services (e.g., service applications and associated hardware components) by a communications backbone that allows the services to communicate with license database 20 and with one another. The services provide an interface between external network entities such as content providers 4 or distributors 6, and license database 20. Each service accepts specific requests from network entities (or users) and performs specific actions relating to these requests in license database 20. Each service will now be discussed in further detail.

The first service of the service set accessible within license clearinghouse 2 is user authentication service 22. User authentication service 22 identifies users to the license clearinghouse 2, and allows the license clearinghouse 2 to identify itself to the users. Users in this instance refers not only to end users 8, but also to content providers 4, distributors 6, third-party processors 10 (e.g., a payment processor 14), and even other license clearinghouses 2.

The level of authentication can vary depending on the type of user. For example, a content provider 4 may require strong authentication using digital certificates, whereas an end user 8 may require only a valid e-mail address for authentication. The digital certificate is part of an established Public Key Infrastructure (PKI) to ensure the certificate is valid and held by the correct party. It allows for authentication and non-repudiation of signed content. User authentication may also be performed using other standard network authentication systems such as Kerberos. The level of authentication for users depends on the functions they will be performing on the license clearinghouse 2, and on the type and value of the licenses that are being created and distributed. User authentication service 22 can be used for the generation of digital certificates for users that need to digitally sign licenses information, and can be used by authentication services of other license clearinghouses 2 to determine if a particular user has permission to perform a specific activity on a license clearinghouse 2.

As shown in FIG. 2, the second service of the service set accessible within license clearinghouse 2 is license generation service 24. License generation service 24 allows content providers 4 to create new licenses, and allows distributors 6 to modify licenses by extending license terms and adding distribution rules and data. License generation service 24 manages license construction, creation of license identifiers (IDs) and keys, and the encryption and digital signing of license information. Distribution rules are rules that define, for example, how and when certain licenses are to be distributed, the level of authentication necessary, and any other information that may pertain to the distribution of the license and/or content.

With continued reference to FIG. 2, the third service of the service set accessible within license clearinghouse 2 is license inventory service 26. License inventory service 26 is used by content providers 4, distributors 6, and end users 8 to manage their licenses stored in the database 20. License inventory service 26 is comprised of several management functions for different “users” (e.g., content providers 4, distributors 6, and end users 8), which may include browsing their inventory, browsing other users' inventories if they have permission, inventory searching capabilities, and license acquisition functions. The license acquisition functions allow users to acquire ownership of licenses from other users participating in the digital license distribution system 100, which may or may not require that a payment be made in conjunction with the transfer. Manners of making payment will be discussed in further detail below. License inventory service 26 can also be used to mark currently owned licenses as being available for acquisition by other users of digital license distribution system 100.

As shown in FIG. 2, fourth service of the service set accessible within license clearinghouse 2 is report generation service 28. Report generation service 28 provides reports to users of the digital license distribution system 100. Users can submit requests for specific information in license database 20. Report generation service 28 then formulates an appropriate database query of license database 20. The results of the query are then returned to the user. The reports can contain information on license status, license activity, user activity, license acquisition, license downloads, and other information that can be represented by querying the database. Report generation service 28 allows users to create new types of reports, schedule reports, and specify to whom the reports are distributed to.

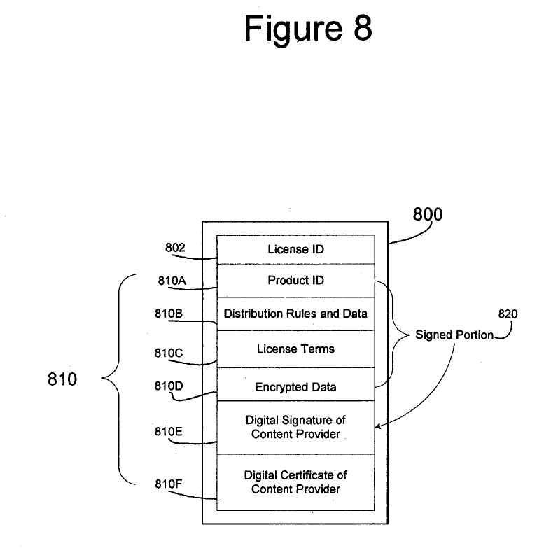

The fifth service of the service set accessible within license clearinghouse 2 is license download service 30, as shown in FIG. 2. License download service 30 allows users to download many different types of license products from license clearinghouse 2. License download service 30 is responsible for creating the license packs from license information in license database 20. As stated above, license pack is a collection of one or more digital licenses (e.g., of several different kinds, perhaps), for use by a user (e.g., an end user 8 or distributor 6), and generally, although not necessarily, at one site. Once the user has obtained a digital license pack, he can install the licenses, or unpack the license pack and distribute the individual licenses contained within. The various types of licenses, license packs and which entity (i.e., content provider 4 or distributor 6) may create each type will be discussed in more detail below with reference to FIGS. 8-10 and 20-24.

The sixth service of the service set accessible within license clearinghouse 2 depicted in FIG. 2 is license activation service 32. License activation service 32 handles license activation requests from users, which generally are end users 8, but may also be distributors 6. Licenses are often distributed in a form that requires an activation code before the license becomes active on the user's hardware. To do this, users submit an installation code to license activation service 32. License activation service 32 then parses the installation code and generates an activation code from license information stored in license database 20 and user information in the installation code. The activation code is then returned to the user, allowing him to activate the license on his hardware and access the licensed content.

The seventh service of the service set accessible within license clearinghouse 2 depicted in FIG. 2 is clearinghouse communications service 34. Clearinghouse communications service 34 is used to share database information and perform transactions with other license clearinghouses 2 in digital license distribution system 100. Clearinghouse communications service 34 handles requests from other license clearinghouses 2 by translating the requests into actions performed on license database 20 by other services in the license clearinghouse 2. For example, it may allow users of license clearinghouse 2A to browse the inventories of users on license clearinghouse 2B or 2C and acquire those licenses if they wish.

License clearinghouse 2 may also contain third-party processor client 36 that interacts with third-party processors such as payment processors 14. This allows payment processing that is not directly related to license distribution to be offloaded to processors that specialize in a particular area. It is to be understood that licenses can be acquired without a financial transaction for content such as shareware or freeware and time-trial content.

3. Relationship of Clearinghouse to Other System Entities

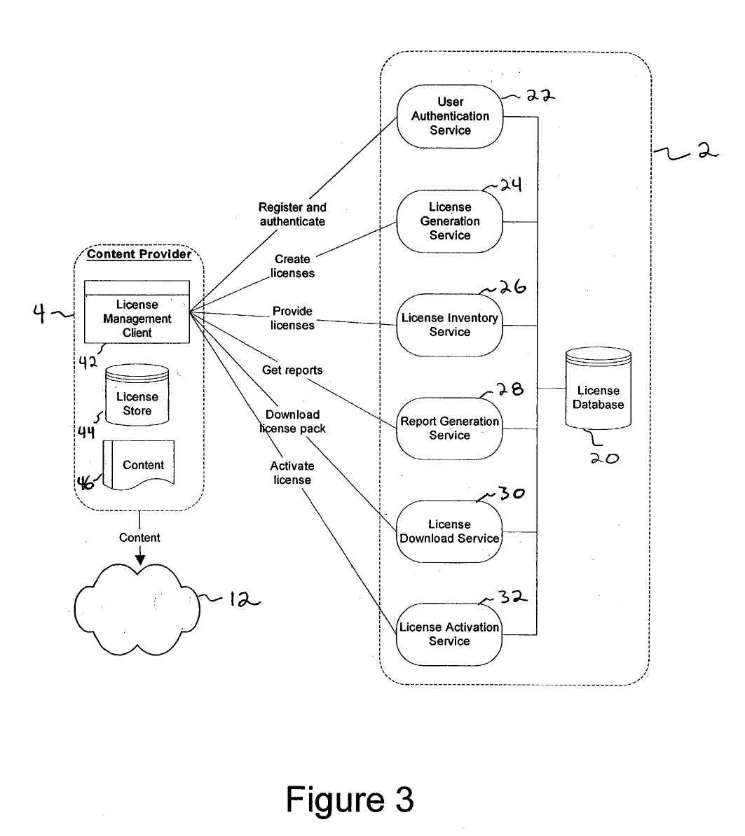

FIG. 3 illustrates the logical structure of a content provider 4 and its service relationship with a license clearinghouse 2 in a digital license distribution system 100 in accordance with an embodiment of the invention. Content provider 4 contains license management client 42, which is used to communicate with license clearinghouse 2. License management client 42 allows content provider 4 to register and authenticate itself as a license clearinghouse 2 user, create licenses, access inventories, provide licenses for acquisition by other users of license clearinghouse 2, generate reports, download licenses and license packs, and activate licenses. License management client 42 can store downloaded licenses in license store 44. The licenses may then be distributed with the licensed digital content or software 46 on content provider's 4 content distribution network 12 or via a separate distribution network.

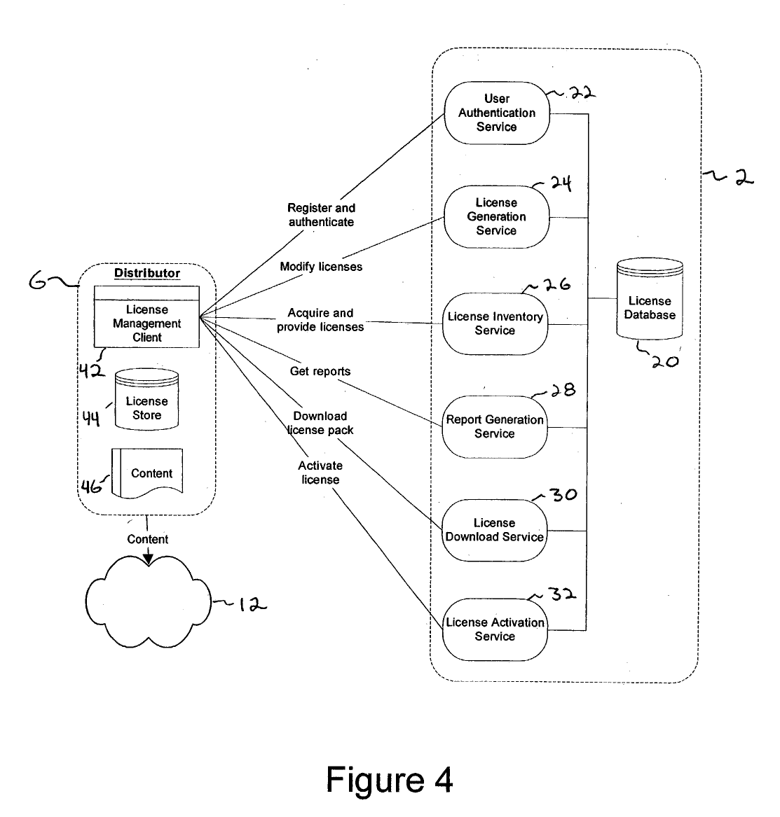

FIG. 4 illustrates the logical structure of a distributor 6 and its service relationship with a license clearinghouse 2 in a license distribution system 100 in accordance with an embodiment of the invention. Distributor 6 contains license management client 42, which is used to communicate with license clearinghouse 2. License management client 42 allows distributor 6 to register and authenticate itself as a license clearinghouse 2 user, modify licenses by extending license information, access inventories to acquire licenses or provide licenses for acquisition by other users of license clearinghouse 2, generate reports, download license packs, and activate licenses. License management client 42 can store downloaded licenses in local license store 44. The licenses may then be distributed with license content 46 on the distributor's content distribution network 12 or via a separate distribution network.

By way of an example, when a content provider 4 sends a request to create licenses, license IDs and keys are created and added to the database 20. The licenses are then added to the content provider's license inventory in the database 20. The providers can browse their corresponding inventory to search and view the licenses they have created. Distributors 6 can modify existing licenses that they have purchased or acquired from content providers 4 and other distributors 6. However, distributors preferably cannot change the content of the original license. They instead can only add to it and combine/repackage license(s) into other licenses. The distributors can also browse their corresponding inventory.

Content providers 4 and upstream distributors 6 can mark licenses for sale in their respective inventories. They can limit to whom the license is sold, or they can make it open to everyone. They are also able to get sales reports indicating who has purchased the licenses that are for sale, or acquired licenses that have been made available for acquisition. Downstream distributors 6 and end users 8 are able to browse for licenses in the respective inventories of the license seller/provider that are for sale or are otherwise available to acquire and to purchase or otherwise acquire licenses. The system 100 includes a mechanism to request licenses from the seller or provider if the licenses are not currently available.

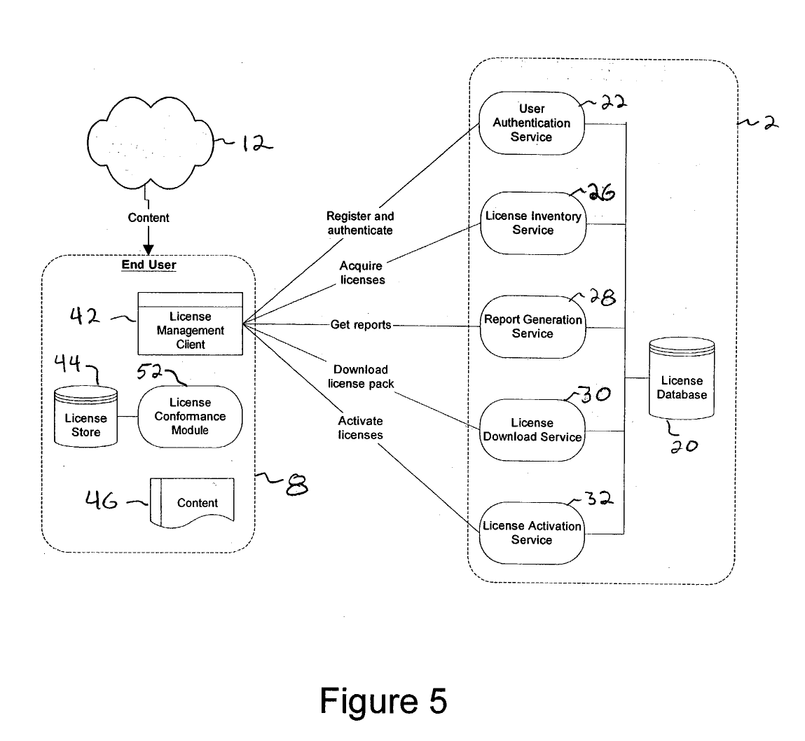

FIG. 5 illustrates the logical structure of an end user 8 and its service relationship with a license clearinghouse in the digital license distribution system 100 in accordance with an embodiment of the present invention. End user 8 comprises a license management client 42, which is used to communicate with license clearinghouse 2. License management client 42 allows end user 8 to register and authenticate itself as a license clearinghouse 2 user, access inventories to acquire licenses, generate reports, download licenses and license packs, and activate licenses and license packs. Downloaded licenses (and license packs) are stored in local license store 44 and are accessible by license compliance module 52. License compliance module 52 uses the licenses in license store 44 to control access to the license content 46, which the user obtains from content distribution network 12.

By way of an example, an end user 8 can browse a license inventory in database 20 and purchase or acquire license packs that are for sale or are otherwise available to them. Once the sales transaction is complete, if payment is needed, the end user can download the license pack from the clearinghouse 2. Since licenses are downloaded in a deactivated state, the user also downloads the activation codes to activate the licenses. The user then installs the license pack on his local system and activates the licenses. Depending on the type of license and the type of license enforcement in place on their system, the user 8 may be required to connect to the clearinghouse 2 to validate the authenticity of his license before using software/content that the license applies to.

Licenses can also be purchased, downloaded, and activated in a multi-client end user environment where the internal clients download and activate licenses from an internal license server. The end user 8 purchases or acquires the license pack and downloads it from the clearinghouse 2. The end user 8 installs the license pack in the license server. He also downloads the license activation codes and installs them in the license server. The licenses are downloaded and activated for internal clients as requests are made to the license server.

Licenses can also be purchased, downloaded, and activated in a multi-client end user environment where the internal clients download licenses from an internal license server, but activate the licenses using the clearinghouse services. The end user 8 purchases or acquires the license pack and downloads it to the local license server. The licenses are then distributed to local clients in a deactivated state. The client is then required to register with the clearinghouse 2 to get an activation code for the license. If license enforcement is in place, the client may have to contact the clearinghouse to validate the authenticity of the license before using the software/content. The end user can get activation reports to see what licenses have been activated and who activated them.

In addition, licenses can be purchased, downloaded, and activated in a multi-client end user environment where the internal clients download and activate the licenses from the clearinghouse services. This involves a party 8 that is responsible for license purchasing or acquisition that purchases or otherwise acquires the licenses. The clients can then register with the clearinghouse 2 to download and activate the purchased or acquired licenses. The party that purchased or acquired the licenses can then get reports detailing the clients that have downloaded and activated licenses.

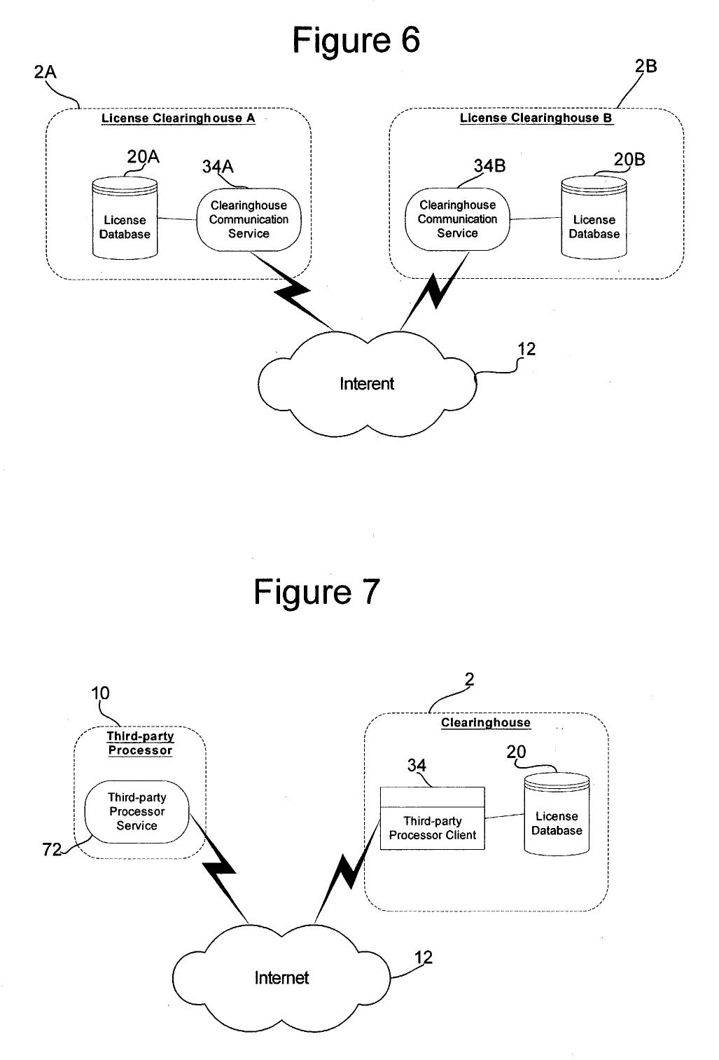

FIG. 6 illustrates a service relationship between two license clearinghouses 2 in the digital license distribution system 100 in accordance with an embodiment of the invention. Clearinghouse communication service 34A, in license clearinghouse 2A, may communicate with clearinghouse communication service 34B, located in license clearinghouse 2B, via Internet 12 or other communication network to exchange database 20 information and process transactions on behalf of their users.

FIG. 7 illustrates a service relationship a between a license clearinghouse 20 and a third-party processor 10 in the digital license distribution system 100 in accordance with an embodiment of the invention. License clearinghouse 2 can connect to an external processor service (,e.g., third-party processor 10) and exchange database information using third-party processor client module 34 which runs on license clearinghouse 2. This module is generally provided by third-party processor 10. Third-party processor 10 uses third-party processor service 72 as a communication tool to facilitate communications between itself and license clearinghouse 2.

Licenses and System Operation

FIGS. 8-10, and 20-24 illustrate eight types of licenses that may be created and used in accordance with various embodiments of the invention. Each will be discussed in detail in the following paragraphs. There are two main types of licenses. Those created by content provider 4 and those provided by distributor 6. As stated above, distributors 4 do not “create” any licenses, but may repackage licenses into license packs and/or change certain terms contained within the digital licenses created by content providers 4. There are preferably two operations a distributor 6 can perform on a license. The first is “modification” or “modifying”. When a first distributor 6 has modified a license (of any type), it means it has purchased or otherwise rightfully acquired the license and has signed it digitally, indicating its ownership. By definition, therefore, all licenses a first distributor 6 acquires are modified. Some licenses can be acquired by a first distributor 6A from a second distributor 6B. The second operation a first distributor 6 can perform on the acquired license is “extending”, or making a license an “extended” license. An extended license is, first, a modified license and, secondly, one that has had certain terms (i.e., distribution rules, and data and license terms) changed by a first distributor 6A. Modifying a license is relatively simple and therefore is not discussed in further detail. The balance of the discussion regarding distributors 6 and licenses concerns the extended license, that is, licenses with their terms and distribution rules and data changed. There are four types of extended licenses, and these are discussed in detail below. Table I, shown below, summarizes the eight types of licenses, their definition, who creates them, and the figure herein that illustrates the creation of the license.

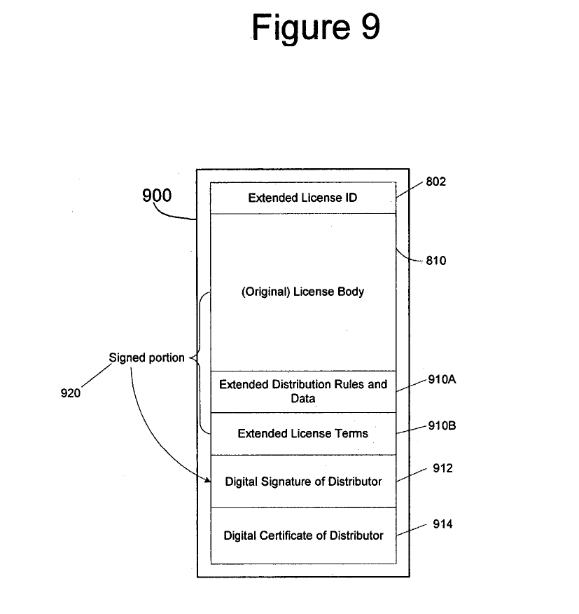

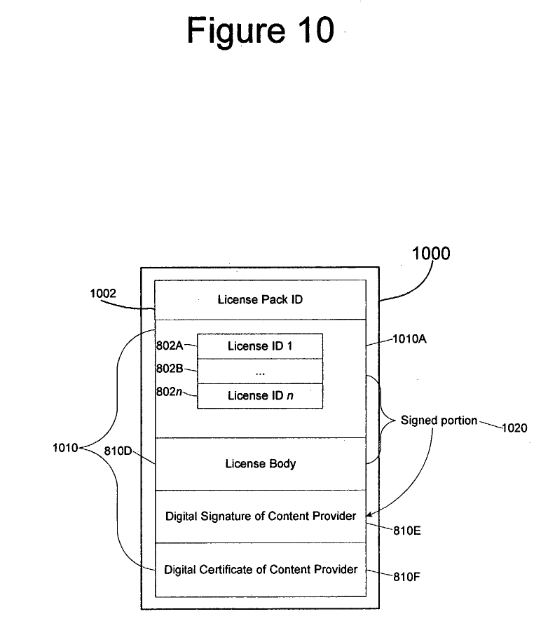

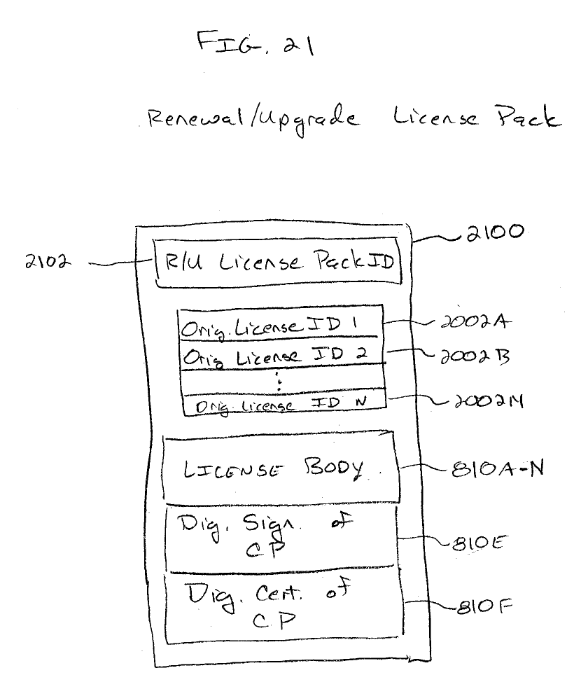

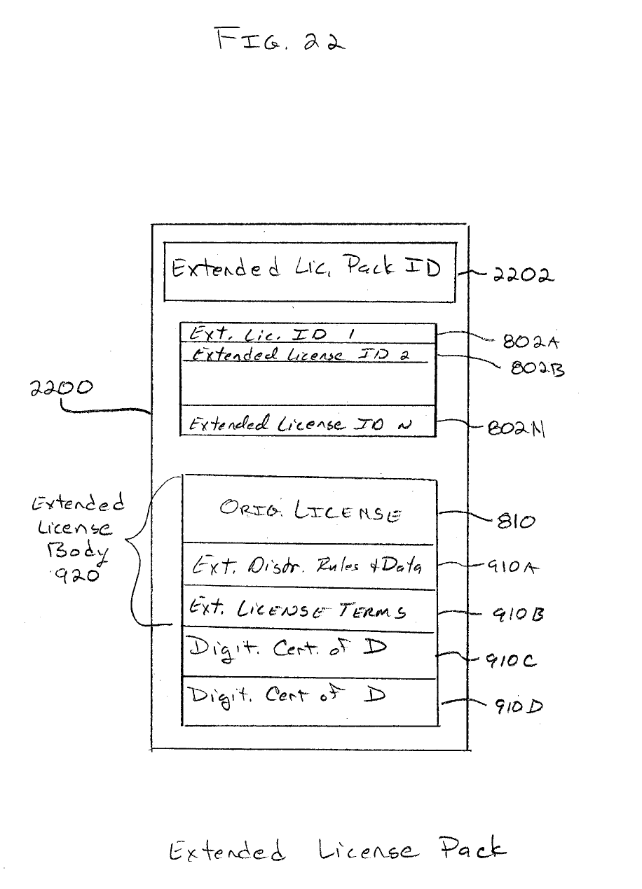

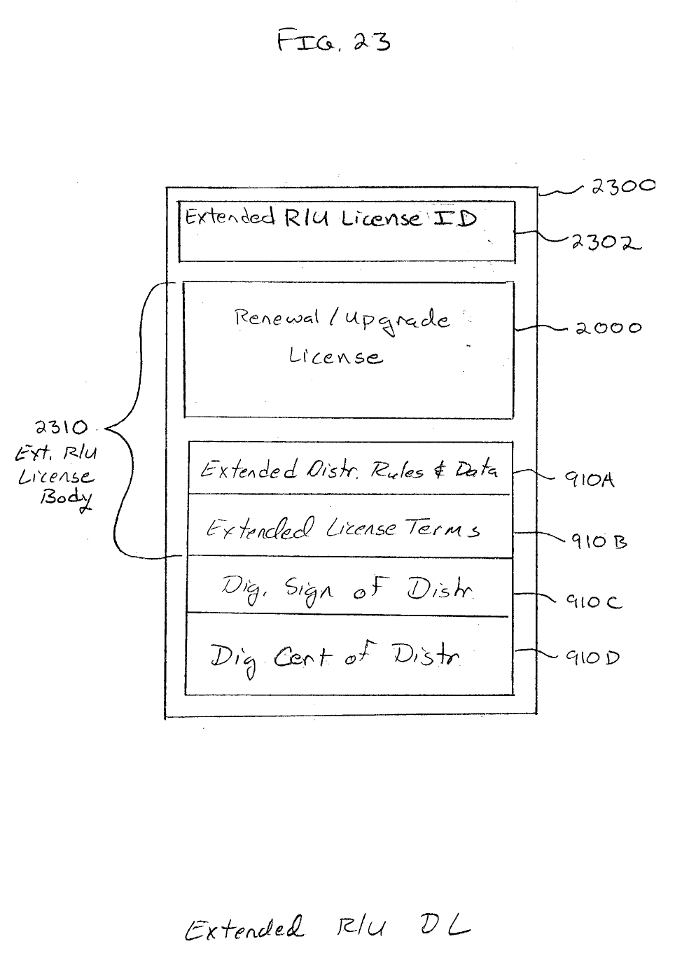

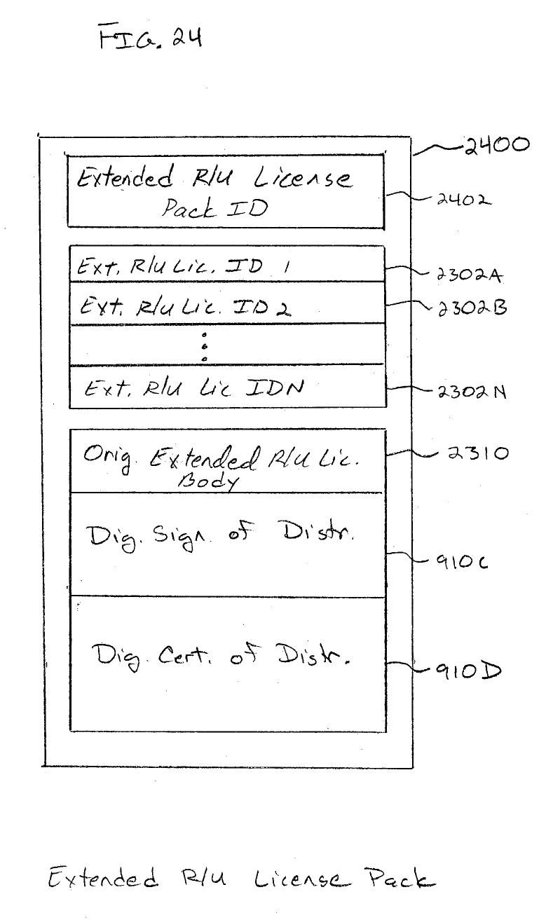

TABLE I

| | | | | Method |
|---|---|---|---|---|
| | | | Crea- | to |
| Type | Definition | Abbr. | tor | Create |
| Digital License | Original license, created by | DL | CP | FIG. |
| (FIG. 8) | CP for users of content | | | 11 |
| Digital License | A collection of DL's | DLP | CP | FIGS. |
| Pack (FIG. 10) | assembled by the CP, e.g., | | | 13, 14 |
| | for multiple users at a | | | and 25 |
| | location | | | |
| Renewal/Upgrade | A DL that is used to renew | R/U-DL | CP | FIG. |
| Digital License | some or all the terms of the | | | 11 |
| (FIG. 20) | original license, or provides | | | |
| | an upgrade feature. | | | |
| Renewal/Upgrade | A License Pack of R/U- | R/U- | CP | FIG. |
| Digital License | DL's assembled by the CP; | DLP | | 25 |
| Pack (FIG. 21) | i.e., for use at a site with | | | |
| | multiple users wishing to be | | | |
| | renewed or upgraded. | | | |
| Extended Digital | A DL that has had some or | EDL | D | FIG. |
| License | all of the modifiable terms | | | 12 |
| (FIG. 9) | modified by the distributor | | | |
| Extended Digital | A License Pack of DLs, | EDLP | D | FIGS. |
| License Pack | each one being extended by | | | 15, 16 |
| (FIG. 22) | the D | | | and 26 |
| Extended | A renewal upgrade license | E-R/U- | D | FIG. |
| Renewal/Upgrade | that has been extended (i.e., | DL | | 12 |
| Digital License | modified) by the D. | | | |
| (FIG. 23) | | | | |
| Extended | A License Pack, created by | E-R/U- | D | FIG. |
| Renewal/Upgrade | the D, of R/U DLs | DLP | | 26 |
| Digital License | | | | |
| Pack (FIG. 24) | | | | |

FIG. 8 illustrates the structure of a digital license created by a content provider 4 in accordance with an embodiment of the invention. Digital License 800 is preferably comprised of two main parts: license ID 802, and license body 810. License ID 802 is preferably a unique number, and indicates the existence of a license. License body 810 comprises license information such as distribution rules and data, and license terms, among other information. Many unique license ID's 802 can be generated for a given license body 810, so that licenses ID's 802 and license body 810 can be stored separately in license database 20. In the illustrated example, license body 810 comprises a product ID 810A, distribution rules and data 810B, license terms 810C, encrypted data 810D, the content provider's digital signature 810E, and the content provider's digital certificate 810F.

Encrypted data 810D is preferably comprised of content access information supplied by content provider 4. It is encrypted with a license key that is generated by license clearinghouse 2 and stored in license database 20. Content access information generally consists of data that is required to execute software or access the digital content 46 that is being licensed. Signed portion 820 is preferably comprised of product ID 810A, distribution rules and data 810B, license terms 810C and encrypted data 810D.

A license can exist in one of three states: (1) pre-activated—a key portion of the license is encrypted and requires an activation code obtained from the clearinghouse before it can be used to access the content it is associated with; (2) activated—license is not encrypted and may be used immediately to access the content it is associated with; and (3) expired—the license is violating one of its terms and can no longer be used. A license is put in a pre-activated state by encrypting it with a license key at the clearinghouse 2. The license key is then associated with the license ID in the database 20. Once a license comes into the possession of a user of the system (either through creation or acquisition), the license is digitally signed by the user. This is optional if the user is an end user 8. Licenses can be transferred from one party to another in either a pre-activated state or in an activated state.

FIG. 9 illustrates the structure of an extended digital license created by a distributor 6 in accordance with an embodiment of the invention. Extended digital license 900 comprises original license ID 802 and a modified body that contains the original license body 810 and extended information 910. The original license body 810 cannot be modified directly because it contains the digital signature 810E of the creator (i.e., a content provider 4). The extended information 910 contains extended distribution rules and data 910A and extended license terms 910B. Extended digital license 900 also contains signed portion 920, digital signature of distributor 912, and digital certificate of distributor 914. Signed portion 920 is preferably comprised of (original) license body 810, extended distribution rules and data 910A and extended license terms 910B.

FIG. 10 illustrates the structure of a digital license pack created by a content provider 4 in accordance with an embodiment of the invention. Digital license pack 1000 is comprised of a license pack ID 1002, and license pack body 1010. License pack body 1010 contains a list of one or more license ID's 1010A, the license body associated with license ID's 810D, digital signature of content provider 810E and digital certificate of content provider 810 F. The license ID's 1010A and the license body 810D are digitally signed by the owner of the licenses (e.g., a content provider 4) and digital certificate of content provider 810F is attached.

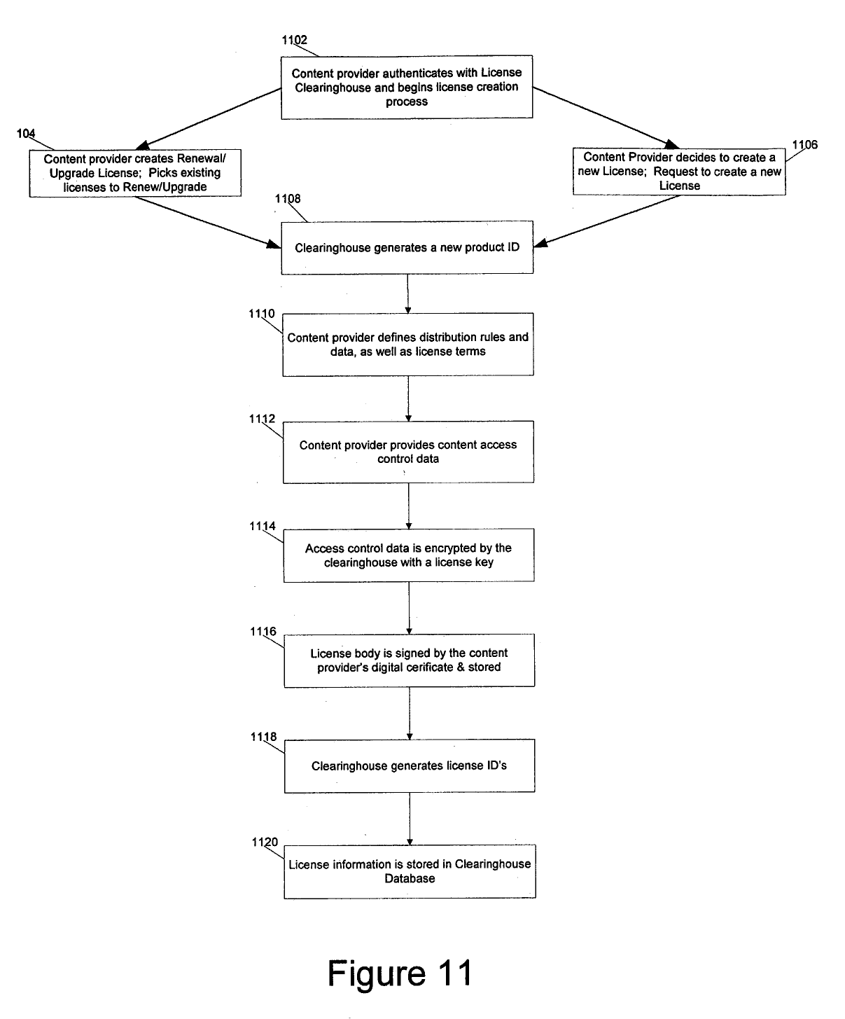

FIG. 11 illustrates a flow diagram of a method for creating a digital license or an renewal/upgrade digital license by a content provider 4 in accordance with an embodiment of the invention. Content provider digital license creation method (method 1100) creates either digital licenses 800 or renewal/upgrade digital licenses 2000 (FIG. 20) on license clearinghouse 2. Method 1100 starts with content provider 4 authenticating itself as a user of digital license distribution system 100 (and, therefore, of a license clearinghouse 2) via user authentication service 22 in step 1102. Content provider 4 decides whether it will create a completely new digital license 800 (step 1106) or a renewal/upgrade digital license 2000 (step 1104). In step 1104, content provider 4 has decided to create a renewal/upgrade digital license 2000 and picks an existing digital license 800 to renew and/or upgrade, by identifying the corresponding license IDs 802 with license clearinghouse 2.

If content provider 4 has decided to create a new digital license 800, content provider 4 starts the license creation process by requesting that a new license be constructed. In step 1108, license clearinghouse 2 assigns a unique license ID to identify the license body 810. In the case of a digital license 800, this would be license ID 802, and, in the case of a renewal/upgrade-digital license 2000, it would be renewal/upgrade license ID 2002.

Content provider 4 defines the distribution rules and data 810B, and license terms 810C in the case of a new digital license 800, and adds renewal/upgrade distribution rules and data 2004 and renewal/upgrade license terms 2006 if a renewal/upgrade-digital license 2000 is being created (step 1110). In step 1112, content access information is then supplied by content provider 4. The content access control data contains information that is required to execute the software or access the digital content that is being licensed (as discussed above). In step 1114, the content access information is encrypted using a unique license key generated by license clearinghouse 2.

In step 1116, content provider 4 digitally signs product ID 810 A, distribution rules 810B, license terms 810C and encrypted data 810D (License Body) with digital signature of content provider 810E, to create signed portion 820. For a renewal/upgrade digital license 2000, content provider 4 digitally signs (with content provider digital signature 810E) original license ID 802, product ID 810A, renewal/upgrade distribution rules and data 2004, renewal/upgrade license terms 2006 and encrypted data 810D (renewal/upgrade digital license body), to create signed portion 2010. The license body information is then stored in license database 20. After the license body has been created and digitally signed, content provider 4 can request a set of license ID's be generated and associated with the license body in the database 20 by license clearinghouse 2 (step 1118). A complete digital license 800 or renewal/upgrade digital license. 2000 is then stored in the clearinghouse database 20 (step 1120).

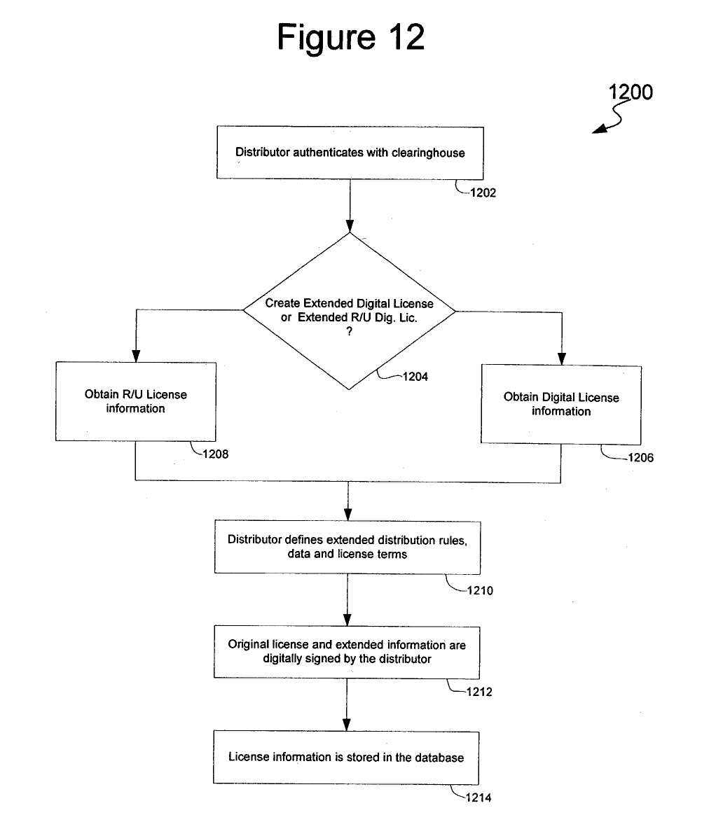

FIG. 12 illustrates a flow diagram of a method for creating an extended digital license or an extended renewal/upgrade digital license by a distributor 6 in accordance with an embodiment of the invention. As stated above, distributors 6 are not allowed to create new licenses, but they can modify or extend existing licenses that they have acquired from content providers 4 and other distributors 6.

Distributor extended digital license creation method 1200 (method 1200) begins with distributor 6 authenticating itself with license clearinghouse 2 in step 1202. In step 1204, distributor 6 indicates whether it wants to create an extended digital license 900 or an extended renewal/upgrade digital license 2300. In step 1206, distributor 6 has decided to created extended digital license 900 and obtains digital license 800 information from license clearinghouse 2. In step 1208, distributor 6 has alternatively decided to create an extended renewal/upgrade digital license 2300 and obtains renewal/upgrade digital license 2000 information from license clearinghouse 2. In step 1210, distributor 6 defines the extended distribution rules, data and license terms for either an extended renewal/upgrade digital license 2300 (FIG. 23) or an extended digital license 900 (FIG. 9). In step 1212, the original license and extended information are digitally signed by the distributor 912, to create signed portion 920 (in the case of an extended digital license) or, signed portion 2310 (in the case of an extended renewal/upgrade digital license 2300). Distributor 4 uses this method to validate ownership of the licenses after they have been acquired from content providers 4 and other distributors 6. Lastly, in step 1214, the entire license information is stored in license database 20 in license clearinghouse 2. If a downstream distributor 6 or end user 8 acquires the license, they can verify that the license was authentically owned by the distributor 6 by checking the digital signature of the license.

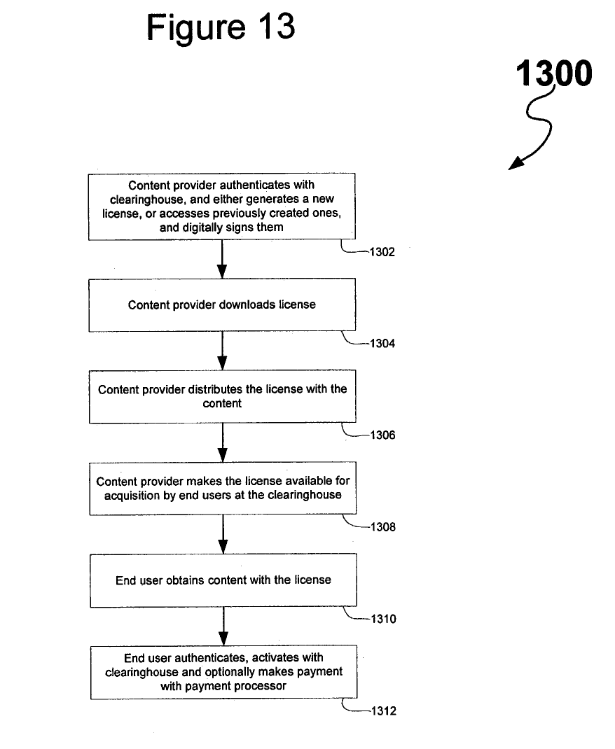

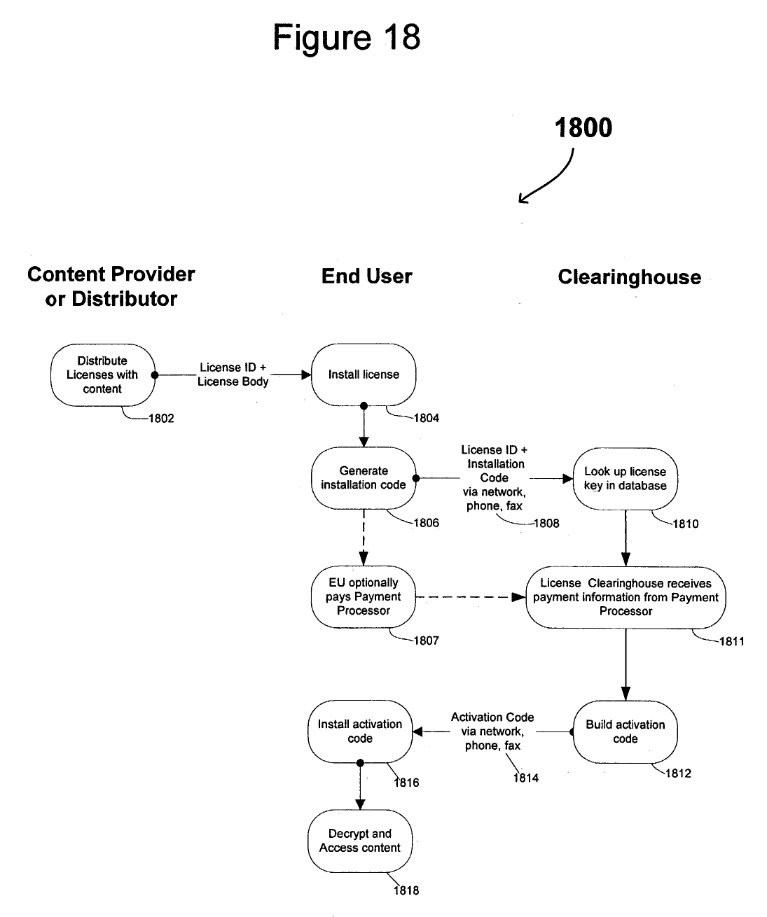

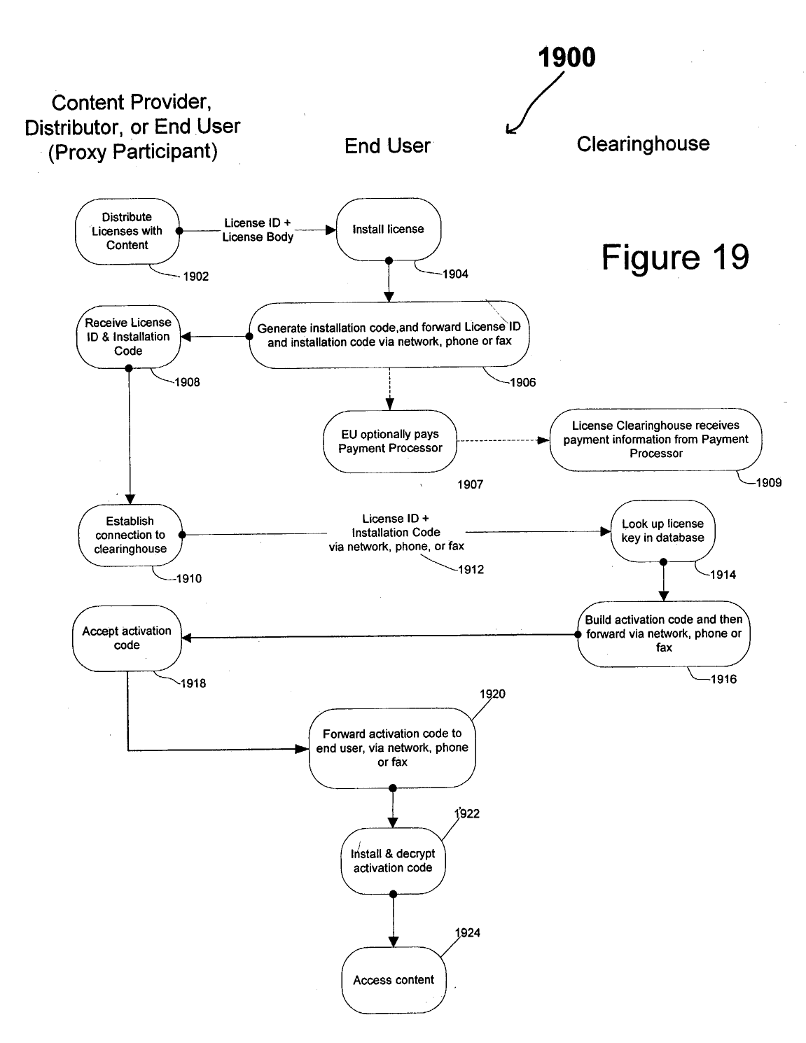

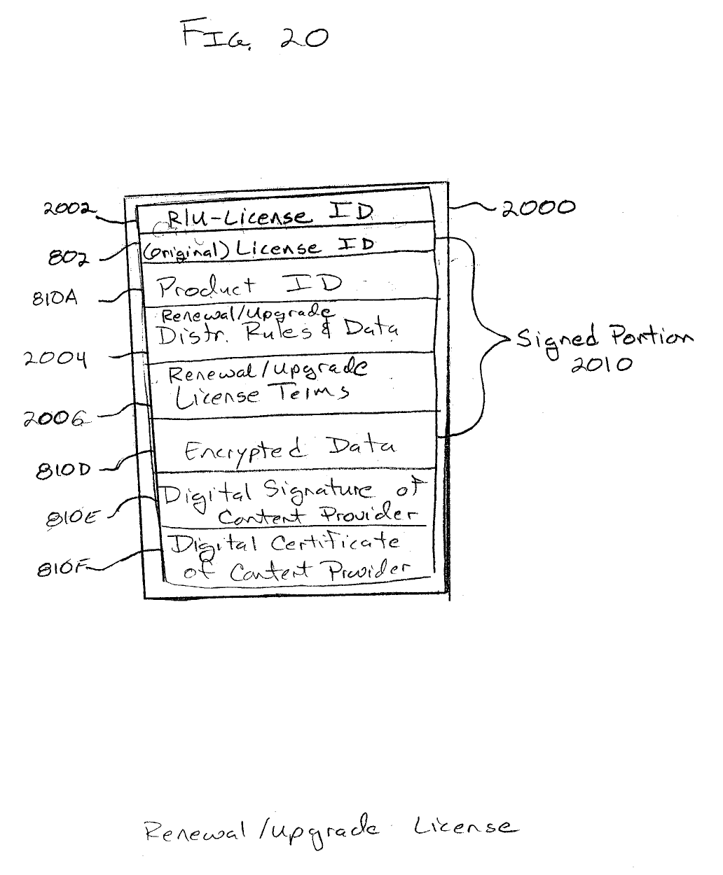

FIG. 13 illustrates a flow diagram of a method for a content provider 4 to transfer ownership of a license or a plurality of licenses in a license pack to an end user 8 in accordance with an embodiment of the invention. In step 1302, content provider 4 authenticates itself with license clearinghouse 2, and either generates new licenses or accesses ones previously created. These licenses are digitally signed by the content provider 4. Content provider 4 then downloads the licenses in preferably the form of a license pack, in step 1304, and distributes them with the associated content in their content distribution network 12 (step 1306). Content provider 4 also makes the licenses available for acquisition by end users 8 on license clearinghouse 2 (step 1308). End user 8 obtains the content and the license from content distribution network 12 in step 1310. In step 1312, end user 8 authenticates itself with license clearinghouse 2 and acquires the license from the content provider. This acquisition may include a payment step. The end user then activates the license by submitting an installation code to the clearinghouse. The clearinghouse returns an activation code to the end user, which is used by the license compliance module 52 (FIG. 5) to allow access to the content. Authentication and activation are discussed in further detail below in reference to FIGS. 18 and 19. Activation and authentication step 1312 may include a payment step whereby the user makes payment with a payment processor 14. The term “license” used in reference to the method illustrated in FIG. 13 can include any type of license that content provider 4 is capable of transferring to end user 8, including digital license 800, digital license pack 1000, renewal/upgrade digital license 2000 or renewal/upgrade digital license pack 2100.

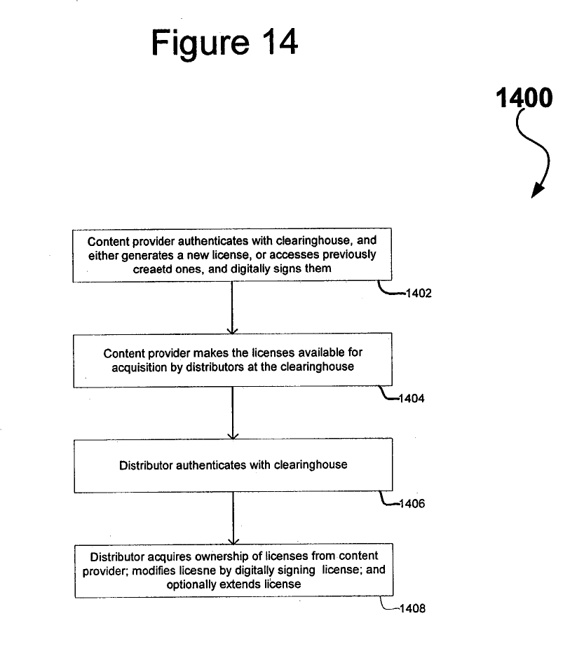

FIG. 14 illustrates a method to transfer ownership of a digital license(s) from a content provider 4 to a distributor 6 in accordance with an embodiment of the invention. In step 1402, content provider 4 authenticates itself with license clearinghouse 2, and either generates new licenses or accesses previously created ones and digitally signs them. Content provider 4 makes the licenses available for acquisition by distributors 6 on license clearinghouse 2, in step 1404. In step 1406, distributor 6 authenticates itself with license clearinghouse 2 and acquires ownership of the licenses from content provider 4 (step 1408). This acquisition may include a payment step. Distributor 6 modifies the license by digitally signing it and may, optionally, extend the license by changing some or all of the terms it is allowed to change.

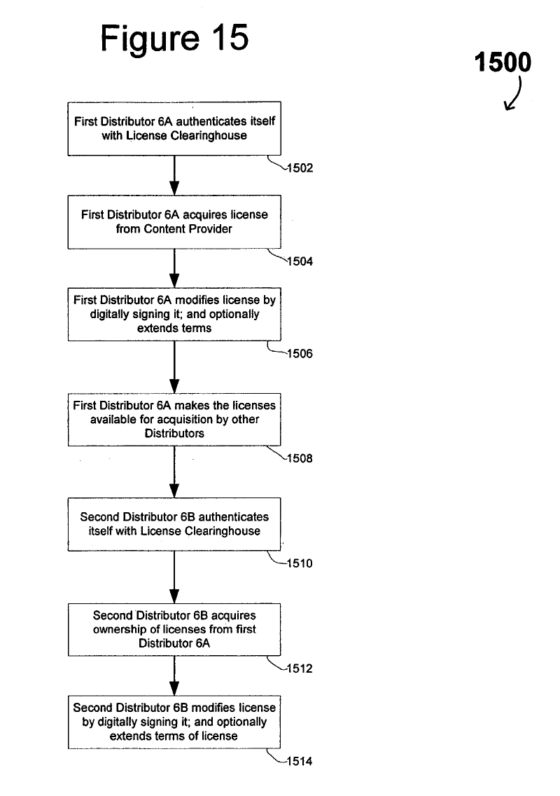

FIG. 15 illustrates a flow diagram of a method for a first distributor 6A to transfer ownership of a digital license(s) to a second distributor 6B in accordance with an embodiment of the invention. In step 1502, first distributor 6A authenticates itself with license clearinghouse 2, generates licenses, and digitally signs them. More specifically, in step 1504, distributor 6A first acquires one or more digital licenses from content provider 4. In step 1506, first distributor 6A modifies the license by digitally signing it and may, optionally, extend its terms by changing some or all of the terms it is allowed to change. Distributor 6A makes the licenses available for acquisition by other distributors on license clearinghouse 2 in step 1508. Another distributor 6B can authenticate itself with license clearinghouse 2 (step 1510), and acquire the licenses from first distributor 6A (step 1512). This acquisition may include an optional payment step. Distributor 6B then modifies the license, in step 1514 (i.e., by digitally signing it), and then may optionally extend terms of the license by changing some or all of the terms it is allowed to change. Distributor 6B may then optionally download the licenses in the forms of a license pack and distribute them with the content in their content distribution network.

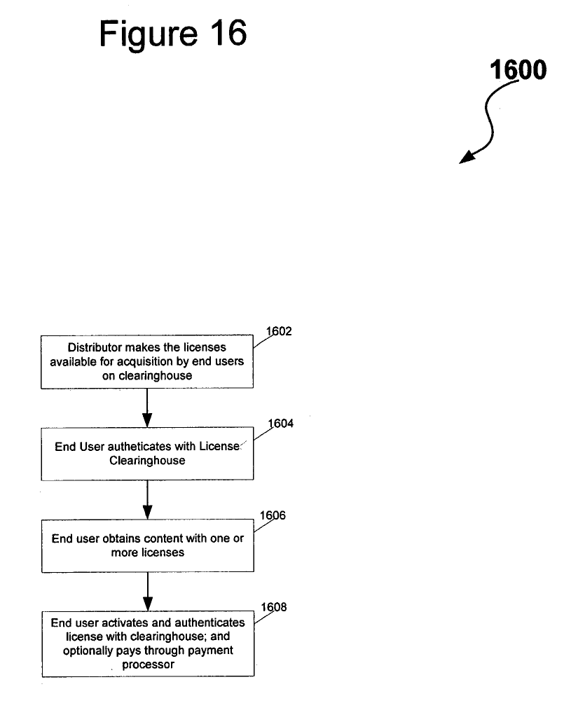

FIG. 16 illustrates a flow diagram of a method for a distributor 6 to transfer ownership of a digital license to an end user 8 in accordance with an embodiment of the invention. In digital license distribution method 1600 (method 1600), it is presumed that distributor 6 has acquired licenses from content provider 4 and at least modified them, as shown and described in FIG. 14. Optionally, distributor 6 may also extend the licenses, as discussed above.

In step 1602, distributor 6 makes the acquired, modified and possibly extended licenses available for acquisition by end user 8 on license clearinghouse 2. Distributor 6 authenticates with the clearinghouse 2 and downloads the licenses in the form of a license pack. Distributor 6 distributes the licenses with the associated content in their content distribution network or via a separate license distribution network. Distributor 6 also makes the licenses available for acquisition by end users 8 on the clearinghouse 2 (step 1602). The end user 8 can obtain the content and the license from the content and license distribution networks, respectively (although one network can be used). The end user authenticates with the clearinghouse 2 (step 1604) and acquires the license from the distributor 6 (step 1606). This acquisition may include a payment step. In step 1608, the end user 8 then activates the license by submitting an installation code to the clearinghouse 2. The clearinghouse returns an activation code to the end user, which is used by the license compliance module 52 (FIG. 5) to allow access to the content.

One of the advantages of the license distribution system 100 is its flexible and comprehensive use of tolerance. Tolerance is a proprietary license term that indicates how many times a license can be activated. For example, a license can contain a tolerance of 5, which means that it can be activated 5 times with different installation codes and activation codes each time. It is associated with the license ID in the clearinghouse database 20, and is decremented each time the license is activated. The essential elements of tolerance are: (1) a tolerance value is defined as a license term in the digital license, and is associated with the license ID in the database 20; and (2) the tolerance value for a particular license ID can be changed in the database 20 at the clearinghouse 2 after the digital licenses have been distributed. A clearinghouse user (e.g., a distributor 6) is preferably only allowed to change the tolerance value if the license terms state that it is allowed.

An example of how tolerance can be used in the system 100 will now be described. A content provider 4 creates a set of licenses for some digital content on a clearinghouse 2, and various distributors 6 buy or otherwise acquire blocks of licenses and sell or otherwise provide them to end users 8. One of the licenses has a tolerance term with a value of 4. There is also a term that states that distributors 6 can increase the tolerance value of the license to 8 at their discretion. If an end user gets a new computer every six months, then each time he gets a new computer, he will need to reinstall the content and reactivate it. The reactivation is needed because the new computer generates a different hardware fingerprint, which results in new installation codes and activation codes being required. The end user 8 therefore uses up all of his activations for the product after two years. After that, the clearinghouse 2 will not allow him to activate the license again and instructs the user 8 to contact the distributor 6. The end user contacts the distributor and explains the situation. The distributor 6 queries the clearinghouse license database 20 to look at the record of previous activations for the license and sees that the same user has been reactivating the license every six months, and there appears to be no misuse (e.g., all of the activations did not occur over a short period of time). The distributor 6 increases the tolerance value for that particular license in the database to 8. The user may now continue to reactivate the content another four times.

There are various scenarios where license tolerance can be important such as: (1) an end user is reinstalling the content but forgets his original activation code; (2) an end user changes some hardware on his computer and then tries to reinstall the content; and (3) an end user wants to activate the content on a new computer. Various additional license terms can be added to restrict license activation, such as: (1) the license terms may require that the same registered end user activates is the license each time; and (2) the license terms allow the license to be installed on a number of computers at the same time, or may require it to be installed on only one computer at a time.

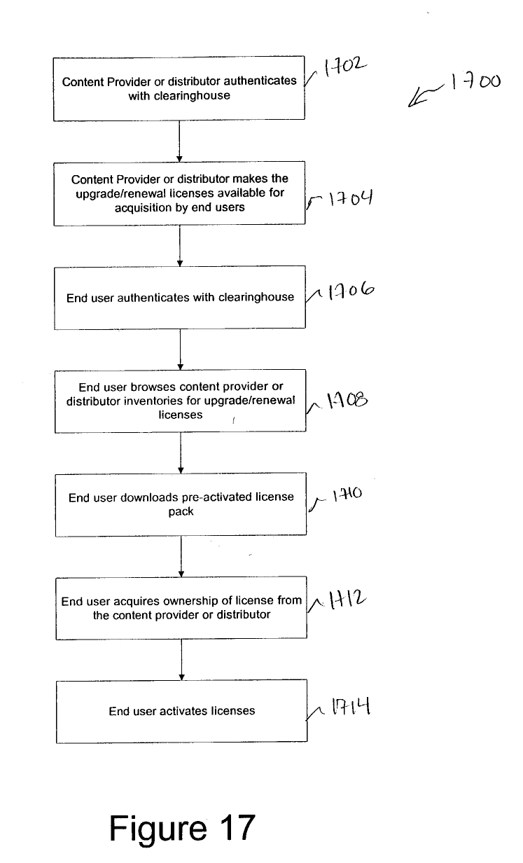

FIG. 17 illustrates the transfer of ownership of upgrade or renewal licenses from a content provider 4 or distributor 6 to an end user 8 in accordance with the present invention. The content provider or distributor authenticates with the clearinghouse 2 (step 1702) and makes the licenses available for acquisition by end users (step 1704). The end user authenticates with the clearinghouse 2 in step 1706, and browses the inventories for update or renewal licenses in step 1708. The user downloads the licenses in the form of a license pack to a local computer in step 1710 before acquiring the licenses from the content provider or distributor on the clearinghouse (step 1712). The acquisition process may include a payment step. The end user then activates the license by submitting an installation code to the clearinghouse (step 1714). The clearinghouse returns an activation code to the end user, which is used by the license compliance module 52 to allow access to the content.

FIG. 18 illustrates a first example of an activation and authentication process used by end users 8 to activate a digital license in accordance with an embodiment of the invention. First activation and authentication method 1800 (method 1800) begins with step 1802 in which content provider 4 or distributor 6 distributes a license or licenses, comprising a license ID and license body, with content to end user 8. In step 1804, the license is distributed with the content in a content distribution network 12, or it may be downloaded directly from license clearinghouse 2. End user 8 installs the license into their license store 44. License store 44 may be managed by a license server. In step 1806, an installation code is generated by license compliance module 52. The installation code contains a unique identifier for end user's 8 device hardware, as well as some product information.

In step 1807, end user 8 optionally decides to pay for the license, and it uses payment processor 14 to make the payment. This information is passed to license clearinghouse 2 in step 1811. In step 1808, the license ID and installation code are then transmitted to license activation service 32 on license clearinghouse 2 by a network connection, or by telephone or facsimile machine. License clearinghouse 2 uses the license ID to look up the license key for the license in license database 20, in step 1810. In step 1812, an activation code is generated by license activation service 32 from the license key and the unique hardware identifier (based on the hardware fingerprint) in the installation code. Step 1812 also requires that a transaction record of the activation request, the generated activation code and any other user data possibly required for registration is added to the database for later retrieval by the licensors. The activation code is then returned to the end user by network connection 12 (e.g., e-mail), telephone or facsimile machine, in step 1814. In step 1816, the activation code is installed with the license in end user's 8 local license store 44. In step 1818, the license key in the activation code is used to decrypt the encrypted portion of the license, which contains the content access control information. License compliance module 52 can now allow end user 8 to access the licensed content.

An advantage of the present invention is the significant granularity in the application of rights models to suit specific business, product or market requirements. In one such model of the rights-modeling scheme of the present invention, rights are delivered or enabled through activation codes. These activation codes for access or enablement of protected content can be generated such that they are only useful for a predetermined period of time, for example. In this scheme, the activation codes are generated using product codes that are computer-dependent by being based on the hardware fingerprint of the computer requesting the activation code.

The license distribution system 100 of the present invention can also employ a content protection scheme whereby user rights (e.g., in terms of the availability of various functions provided in a software program) can be controlled on a feature-specific, application-specific, release-specific, distribution channel-specific or user-specific basis depending upon the attainment of a valid license, as described in the afore-mentioned, commonly-assigned U.S. patent application Ser. No. 10/334,139, filed Dec. 31, 2002. Users can also be provided with an application that allows them to browse or search for items in aggregated datasets, and to purchase or otherwise acquire selected items via a transaction involving the computer-dependent product code and activation code, as described in the afore-mentioned, commonly-assigned U.S. patent application Ser. Nos. 10/126,973 and 10/126,974, both filed Apr. 22, 2002, and in U.S. Pat. No. 6,223,288, which is hereby incorporated herein in its entirety for all purposes. This model also allows for downstream rights acquisition and delivery, that is, rights delivered or modified subsequent to the initial delivery or enablement. Additional rights can be granted or restricted in conjunction with an update or upgrade to the dataset or software.

User authentication verifies the identities of users who want to access and use content and can be implemented via a password, a cookie on a user's computer, a token incorporating a cryptographic algorithm, biometrics, or other technology-based tracking solutions. Through activation-based systems, locking the content use or access to a specific computer provides a convenient and robust user authentication methodology. With these technologies, users do not have to authenticate themselves (e.g., enter a password for every time they initiate previously authorized use of a program or view content), and their computers can automate this task. Such computer authentication systems can be readily combined with user authentication systems such as Microsoft Passport™ so as to seamlessly incorporate the advantages of both.

In accordance with an aspect of the present invention, the system 100 provides content providers 4 and distributors 6 with choices for authentication such as activation only, activation with optional registration, or activation with mandatory registration. Activation preferably employs computer-dependent product codes for user integrity verification, as described in the afore-mentioned, commonly-assigned U.S. Pat. No. 5,809,145.

In accordance with another aspect of the present invention, authentication and integrity validation go beyond user authentication and content integrity. The rights model and the license terms themselves employ authentication and integrity validation for current, as well as subsequent use. In other words, the system can employ license terms authentication and validation. For example, data elements critical to the operation of a software program can be encrypted, as described in the afore-mentioned, commonly-assigned U.S. patent application Ser. No. 10/334,139, filed Dec. 31, 2002, and subject to different license terms. Accessing the data elements then requires searching for installed licenses. A valid license is needed to decrypt a corresponding data element and reveal it; otherwise, the software program can be constructed to operate sub-optimally. In this type of system, license terms validation and computer (i.e. user) authentication is typically automated within this rights system.

FIG. 19 illustrates a second example of a activation and authentication process used by end users 8 to activate a digital license via a proxy content provider 4, distributor 6 or end user 8 in accordance with an embodiment of the invention. The proxy content provider 4, distributor 6 or end user 8 is referred to as the “proxy user.” Method 1900 begins with step 1902 in which a content provider 4, user 8 or distributor 6 sends a digital license, comprising a license ID and license body to an end user 8. The license is distributed with the content in a content distribution network, or it may be downloaded directly from the clearinghouse. In step 1904, end user 8 receives the license, and installs it into license store 44. License store 44 may be managed by a license server.

In step 1906, end user 8 generates an installation code by its license compliance module 52. The license ID and installation code are transmitted to a proxy participant on the clearinghouse 2 by telephone, facsimile, e-mail or otherwise via a network connection. In step 1907, end user 8 optionally pays for the license via the payment processor 14. This information is passed to license clearinghouse 2 in step 1909. In step 1908 (as in steps 1910 and 1918), the proxy user who receives the license ID and installation code may or may not be the same user that distributed the license and content in step 1902.

In step 1910, the proxy user establishes a connection with license clearinghouse 2. In step 1912, the proxy participant forwards the license ID and installation code to license clearinghouse 2 (again, via network 12, telephone or facsimile). In step 1914, license clearinghouse 2 uses the license ID to look up the license key for the license in license database 20. An activation code is generated by license activation service 32 from the license key and the unique hardware identifier in the installation code step ( 1916). Step 1916 also requires that a transaction record of the activation request, the generated activation code, and any other user data possibly required for registration is added to the database for later retrieval by the licensors. The activation code is then returned to the end user via the proxy user by a network connection 12, or via telephone, or facsimile in step 1918 and step 1920. The activation code is stored with the license in the end user's local license store 44. In step 1922, the activation code is installed in end user's 8 computer, and then the license key in the activation code is used to decrypt the encrypted portion of the license, which contains the content access control information. In step 1924, license compliance module 52 can now allow end user 8 to access the licensed content.

FIG. 20 illustrates the structure of a renewal/upgrade digital license created by a content provider in accordance with an embodiment of the invention. Renewal/upgrade digital license 2000 is preferably comprised of two main parts: renewal/upgrade license ID 2000 and license body 2010. Renewal/upgrade license body 2010 is comprised of the original license ID 802, product ID 810A, renewal/upgrade distribution rules and data 2004, renewal/upgrade license terms 2006, and encrypted data 810D. The aforementioned part of renewal/upgrade license body 2010 are collected together to create digital signature of content provider 810E.

A renewal/upgrade digital license 2000 is a digital license previously created by content provider 4 which is modified for a user (generally an end user 8) to be able to use the original digital license 800, but in a renewed/upgraded mode. That is, a renewal/upgrade digital license 2000 is one in which, for example, the original license only allows a certain number of internal transfers. A renewal/upgrade digital license 2000 essentially allows end user 8 to extend the life of the original digital license 800.

FIG. 21 illustrates the structure of a renewal/upgrade license pack created by a content provider 4 in accordance with an embodiment of the invention. Renewal/upgrade license pack 2100 is a license pack created by content provider 4 of a plurality of renewal/upgrade digital licenses 2000. Renewal/upgrade digital license pack 2100 comprises a renewal/upgrade license pack ID 2102, original renewal/upgrade license IDs 2002A-N, license bodies 810A-N, digital signature of the content provider 810E and digital certificate of the content provider 81 OF. A renewal/upgrade digital license pack 2100 is essentially the same as a digital license pack 1000, except that it is comprised of a plurality of renewal/upgrade digital licenses 2000 and given a separate and unique renewal/upgrade license pack ID 2102.

FIG. 22 illustrates the structure of an extended digital license pack created by a distributor 6 in accordance with an embodiment of the invention. Extended digital license pack 2200 is comprised of an extended license pack ID 2202, a plurality of extended license ID's 802A-N, and extended license body 920 comprised of an original license 810, extended distribution rules and data 910 A, extended license terms 910B, digital certificate of the distributor 910C and digital certificate of the distributor 910D. Extended digital license pack 2200 is comprised of extended digital licenses 900, which as discussed above, are digital licenses 800 purchased or otherwise rightfully acquired by a distributor 6 and then extended: modification being an indication of possession or ownership of digital license 800, which allows transfers to other end users of digital license distribution system 100; and extending, which is a change of distribution rules and data or existing licensing terms from what was originally created by content provider 4 in the original digital license 800. Distributor 6 may extend the license terms it has permission to if it feels the market will accept the license with the extended terms.

FIG. 23 illustrates the structure of an extended renewal/upgrade digital license created by a distributor 6 in accordance with an embodiment of the invention. Extended renewal/upgrade digital license 2300 is comprised of an extended renewal/upgrade ID 2302, a renewal/upgrade digital license 2000, extended distribution rules and data 910A, extended license terms 910B, digital signature of the distributor 910C, and the digital certificate of the distributor 910B. The renewal/upgrade digital license 2000, extended distribution rules and data 910A, and extended license terms 910B comprise the extended renewal/upgrade license body 2310. An extended renewal/upgrade digital license 2300 is a renewal/upgrade digital license 2000 which has had its distribution rules data and license terms modified and possibly extended by distributor 6, who purchased or otherwise acquired the renewal/upgrade digital license 2000 from content provider 4.

FIG. 24 illustrates the structure of an extended renewal/upgrade digital license pack created by a distributor 6 in accordance with an embodiment of the invention. Extended renewal/upgrade digital license pack 2400 is comprised of extended renewal/upgrade license pack ID 2402, a plurality of extended renewal/upgrade license IDs 1-N 2302A-N, original extended renewal/upgrade license body 2310, digital signature of the distributor 910C, and digital certificate of the distributor 910D. Extended renewal/upgrade digital license pack 2400 is created by distributor 6 in the same manner as extended digital license pack 2200, in that distributor 6 has purchased or otherwise acquired a renewal/upgrade digital license pack 2100 from content provider 4 and possibly extended license terms and/or distribution data and rules of the original renewal/upgrade digital license pack 2100.

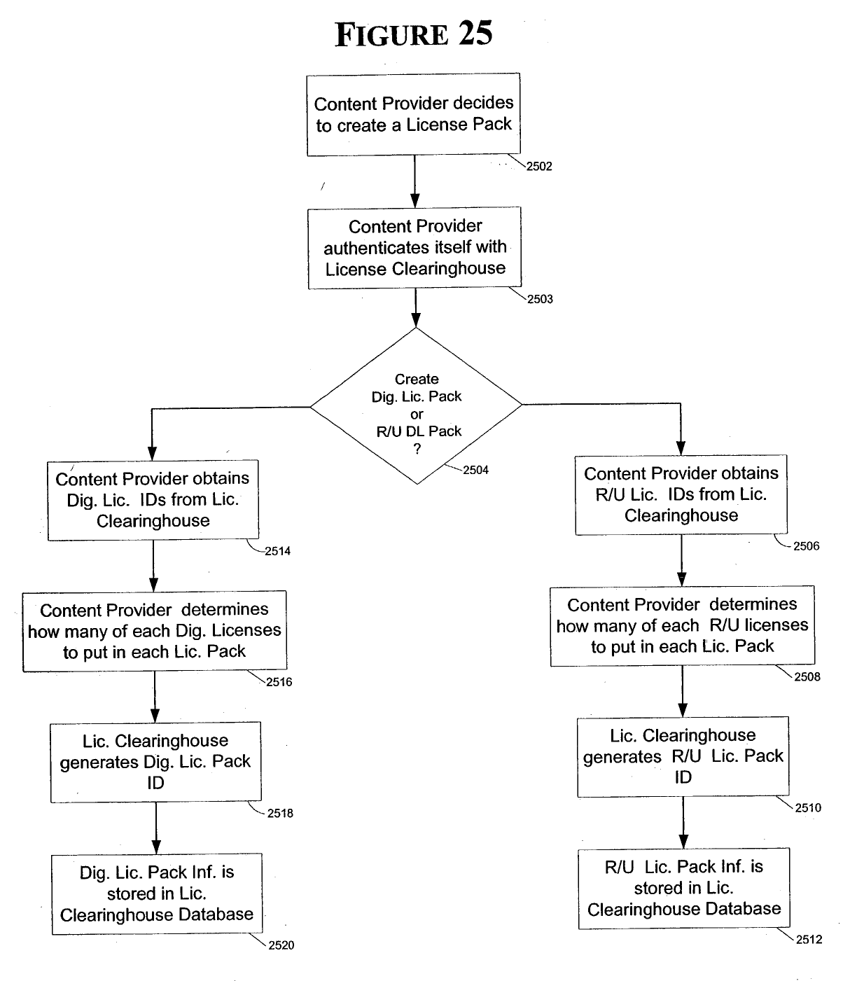

FIG. 25 illustrates a flow diagram for the creation of a digital license pack or a renewal/upgrade digital license pack by a content provider 4 in accordance with an embodiment of the invention. Content provider digital license pack creation method (method 2500) creates either a digital license pack 1000 or a renewal/upgrade digital license pack 2100 on license clearinghouse 2. Method 2500 begins with step 2502 in which content provider 4 decides to create a license pack. In step 2504 a decision is made whether to create a digital license pack 1000 or a renewal/upgrade digital license pack 2100. If a digital license pack 1000 is going to be made, method 2500 proceeds to step 2513 in which content provider 4 authenticates itself as a user of digital license distribution system 100 (and, therefore, a license clearinghouse 2), via user authentication service 22. In step 2514, content provider 4 obtains digital license IDs corresponding to existing digital licenses 800 from license clearinghouse 2. In step 2516 content provider 4 determines how many of each digital license 800 it wishes to put in each digital license pack 1000. In step 2518 license clearinghouse 2 assigns a unique license ID to identify the license body of the digital license pack. This is digital license pack ID 1002. In step 2520 content provider 4 digitally signs product IDs 1010A and license body 810D to create signed portion 1020. This signed portion 1020 uses digital signature of content provider 810E. In addition, digital certificate of content provider 810F is added to the digital license pack. In step 2520, the now completed digital license pack 1000 is stored in license clearinghouse database 20.

If content provider 4 had decided to create a renewal/upgrade digital license pack 2100 method 2500, after step 2504, would proceed to step 2505. In step 2505 content provider 4 authenticates itself as a user of digital license distribution system 100, as was done in step 2513. After step 2505 content provider 4 obtains the renewal/upgrade digital license IDs from license clearinghouse 2. In step 2508 content provider 4 determines how many of each renewal/upgrade digital licenses 2000 it wishes to put in each renewal/upgrade digital license pack 2100. In step 2510 license clearinghouse 2 generates a renewal/upgrade license pack ID 2102. In step 2512 content provider 4 digitally signs renewal/upgrade license pack ID 2102, original license IDs 1-N 2002A-N and license bodies 810A-N to create signed portion 2120. Content provider 4 digitally signs the aforementioned components with content provider digital signature 810E. Lastly, digital certificate of content provider 810F is added to the renewal/upgrade digital license pack 2100. In step 2512, the renewal/upgrade digital license pack is stored in license clearinghouse database 20.

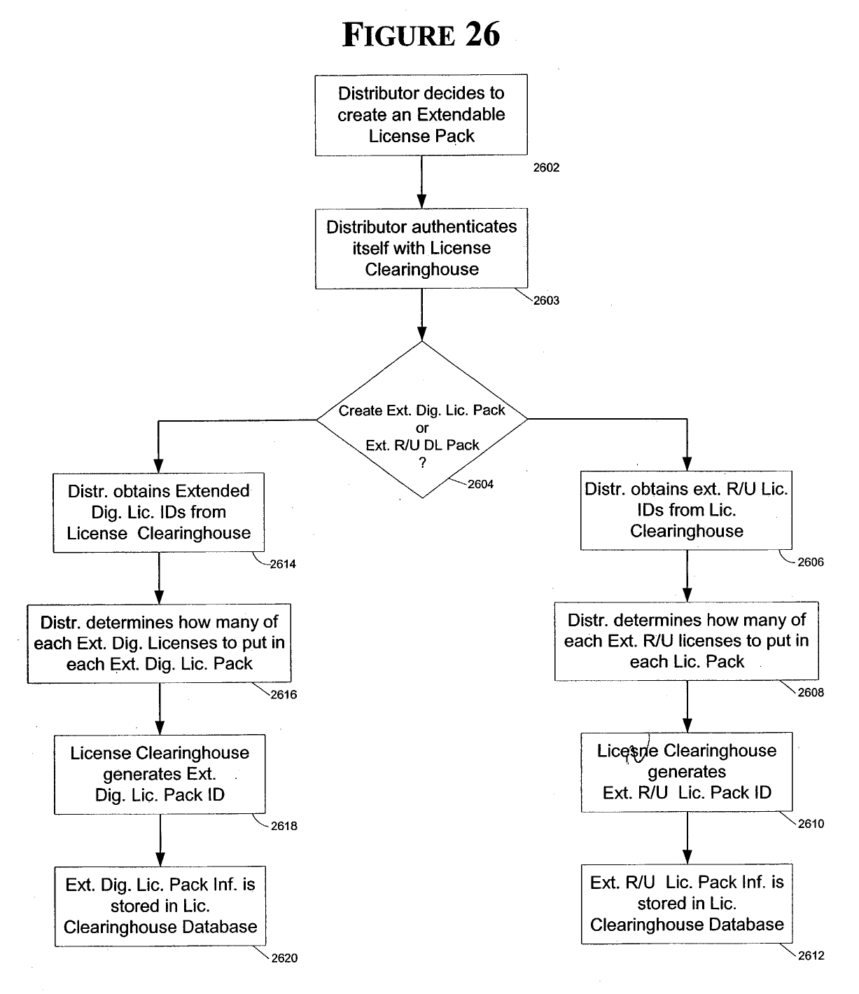

FIG. 26 illustrates a flow diagram for the creation of an extended digital license pack or extended renewal/upgrade digital license pack by a distributor 6 in accordance with an embodiment of the invention. Distributor extended digital license pack creation method 2500 (method 2500) begins with distributor 6 deciding to create an extended digital license pack. In step 2603 distributor 6 authenticates itself with license clearinghouse 2. In step 2604 distributor 6 decides whether to create an extended digital license pack 2200 or an extended renewal/upgrade digital license pack 2400. If distributor 6 decides to create an extended digital license pack 2200 it proceeds to step 2614. In step 2614, distributor 6 obtains digital license 800 information from license clearinghouse 2; or optionally, it obtains extended digital license pack 900 information that it has created previously. That is, distributor 6 can either create an extended digital license pack from “original” digital licenses 800 received directly from content provider(s) 4, or create an extended digital license pack 2200 from previously created extended digital licenses 900. In either event, in step 2616, distributor 6 determines how many of each extended digital licenses it wants to put in each extended digital license pack 2200. In step 2618 license clearinghouse 2 generates an extended license pack ID 2202. Then, distributor 6 defines the extended distribution rules, data, and license terms if using digital licenses 800. In step 2619, the extended license pack ID 2202, extended license IDs 1-N, 802A-N, original license 810, extended distribution rules and data 910A, and extended license terms 910B are digitally signed using digital signature of distributor 912 to create extended license body 920. The digital certificate of distributor 910D is also added to the license. In step 2620 extended digital license pack 2200 is stored in license clearinghouse database 20.

If, in step 2604 distributor 6 had decided to create an extended renewal/upgrade digital license pack 2400, the next step would be step 2606. In step 2606 distributor 6 either obtains renewal/upgrade digital license information from license clearinghouse 2, or it obtains extended renewal/upgrade digital license data for licenses it had already extended. In step 2608 distributor 6 determines how many of each extended renewal/upgrade licenses 2400 it desires to put in each extended renewal/upgrade digital license pack 2400. In step 2610 license clearinghouse 2 generates an extended renewal/upgrade license pack ID 2402. In step 2612, the extended renewal/upgrade license pack information is stored in license clearinghouse database 20.

The license distribution system 100 of the present invention is a license transaction system that combines the best of product activation and copy protection with user registration, channel support and e-commerce capabilities. The system 100 offers software and content publishers flexible, Internet-based solutions for securing software and content and for providing electronic licenses through any distribution channel, and offers users an easier and more convenient means for obtaining protected works and ensuring license compliance.

More specifically, the system 100 is a software license transaction system that supports all channels of distribution and tracks license distribution, while making unauthorized copying difficult and purchasing or acquiring a license easy. The system 100 incorporates product activation, registration, persistent and flexible copy protection, powerful channel support and integrated commerce capability, delivers all of the benefits of an easy-to-use activation system, and adds fully integrated payment and channel support capability.

The license distribution system 100 is a worldwide electronic licensing system that supports Internet and non-Internet connected users in developed and developing countries. Content and software is secured and distributed via the Internet, as well as via more traditional methods such as delivery of copies on a compact disc (CD). Further, activation and registration can be conducted either over the Internet, or by more traditional methods such as telephone, e-mail and facsimile.

While products such as those offered by Globetrotter Software, Inc. (now Macrovision™) track license use, the present invention provides the capability to conduct and track license transactions and activations (which infers users), along with registrations, payment and commerce transactions, etc. as appropriate. Content and software does not have to always accompany the license (but may incorporate part of the locking/unlocking mechanism). As described above, the license distribution system 100 of the present invention operates with a content distribution system (i.e., the same or a different network) that can bundle the content in a protective wrapper that requires a unique license key to unlock. The end-user receives the license key when activating and registering the product. This activation and registration can be conducted either over the Internet, by telephone, e-mail or by facsimile. The system 100 provides copy protection beyond enforced registration by wrapping or encrypting software, or a portion thereof, or other digital content in a self-extracting bundle that can preferably only be decrypted upon successful registration. A license compliance component of the system I 00 is included in the self-extracting bundle.

With further reference to license compliance, software or other content protected by the system 100 is activated when an end user activates an instance of a license as identified by a product serial number. The activation process preferably generates a computer and product-specific key that allows the end user to unlock the software or content. This unlocking key is obtained automatically from the system 100 over the Internet. Users without an Internet connection are not excluded from the installation process since telephone and facsimile registration is also available and can be supported through representatives appointed by the software publisher. The license API employed by the system 100 allows the content provider (e.g., software publisher) to implement persistent copy protection through imbedded license verification checks in, for example, their software. The result is an installation tied to a specific computer. Any attempts to use the software on another computer will fail. CDs can be copied but they have no commercial value unless they are tied to a specific computer with an activation code obtained through the activation process.

In the case of a time-trial license, the, license expires a certain number of days after installation, after a certain number of uses, or after a specific date. Once the license expires, the key for the license becomes unusable.

The license distribution system 100 of the present invention is unique in that the content provider has the choice of three secure solutions: an activation-only system, an activation system with optional registration, or a mandatory registration system. With an activation-only system, end users need not supply any personal information in order to activate their products. While product activation does not require registration of personal data, registration is complementary and can be defined as an optional or a mandatory step in the activation process. The system 100 allows providers the flexibility to define this prior to product release, as well as modify this option post-distribution, allowing the provider to adapt to market and business conditions. In all cases, the activation code that is generated via the license activation service 32 (FIG. 1) can only be used on the computer that originated the request since it is based on that computer's hardware fingerprint, although the system itself is blind to the identity of the computer. The user or computer identification is not compromised in any way. This activation code cannot be used on other computers.

Beyond its successful use for software programs, the license distribution system 100 can be used to control access to all forms of digital content such as digital images, as well as audio and video files. The original content is encrypted and bundled into a package that contains the unwrapping tool, a digital license, and optional preview content or limited trial versions of the software. The wrapped package is a self-extracting executable package. No additional software is required on the end-user's computer to activate, register, unwrap and use the content with the appropriate content processing application. As stated previously, the package can be sent via a content distribution system that is separate from the license distribution system 100.

Thus, the license distribution system 100 makes becoming license compliant simple for users, while addressing unwanted copying since the system integrates a licensing transaction system into a complete e-business platform for software and digital content. An important aspect of the system 100 of the present invention is the ability to define software license terms digitally and to automatically ensure compliance. Further, the system 100 works with or mirrors common and accepted software installation methods and therefore does not distract end users or complicate product usage.

License configuration commences with basic product identification within the database 20 (FIG. 1). The system 100 supports easy configuration of a variety of time-trial licenses (e.g. try-buy software, beta ware), as well as standard unrestricted perpetual licenses. The license format of the present invention is extensible, giving content providers 4 the ability to define and store proprietary license terms securely within the encrypted license. These terms can be recovered and tested using the license API. License terms can be set at any time pre and post-build, and pre and post-distribution. This allows the content provider 4 to augment, enhance or refine the software or content, and the license to provide new features or better serve the market. The system 100 also offers feature-specific licensing whereby the feature would be activated on appropriate use. More specifically, feature-based licensing using the system 100 allows for configuration of a variety of license terms by providers 4 and distributors 6 to be associated with individual features or bundles of features within a product. Feature-based license terms can be selected from the same set of terms that usually apply to the entire product, including arbitrary time-limited and usage-limited trial periods, activation grace periods, expiry dates and subscription terms. Support for the configuration of grace periods by providers 4 in the system 100 is important since it satisfies user desires to immediately use a product for a limited time, if they are unable to complete activation (e.g., due to network problems), while providing persistent copy protection. Since a provider determines the actions to be taken during and after the grace period, activation does not imply a barrier to product usage. The provider can then apply marketing incentives to encourage product activation in a positive, engaging manner. Storing and updating client access licenses for server-type products is also supported by the system 100.

The flexibility that the system 100 provides in this regard, along with its convenience, is unique in Digital Rights Management (DRM). Each license is bundled with software or content that can be freely distributed via CD or ESD or other common systems. Before installing the software or viewing the content, an end user must complete the activation process.

The content provider 4 creates the digital license using the license distribution system 100. The digital license is incorporated into the package and is activated when an end user selects the desired content in a package via the associated serial number and enters the activation code. As stated above, the system 100 supports activation by telephone, facsimile and e-mail, as well as through a secure registration web site. Optional or mandatory registration can be incorporated with activation for customer support and management or for market information purposes. The system can also incorporate payment processing into the activation process so that end users, and even distributors, can purchase the activation code in a completely automated transaction.

Distributors 6 can use the license distribution system 100 to purchase and resell product serial numbers. Content providers can use the system 100 to register users while generating new digital licenses. The registration process in the system 100 allows better management of the terms of these licenses and can generate a variety of powerful registration reports to monitor channel-based activity, license abuses, and even peer-to-peer or peer-referenced sales.

The license distribution system 100 of the present invention combines protection and licensing of software and digital content with powerful e-business tools for distribution management. With regard to distribution management, the system 100 provides partner administration, product administration and asset management, as well as activation, reporting and channel support. As stated above, the system 100 supports Internet and traditional distribution methods.

Existing distribution channels and partners provide substantial benefit to software and digital content providers. The system 100 is a powerful toolset that supports these software demand chain partnerships and expands services and channel capabilities. The system 100 empowers the channel by maintaining customer relationship references from the initial sale. The system allows for referenced targeted marketing, user upgrade tracking, new feature purchases and even viral marketing.

Another advantage of the present invention relates to the dispensing and use of serial numbers (e.g., for software products) in the license distribution system 100. The system 100 provides instant, and fully automated, fulfillment. Instant fulfillment is accomplished via special transaction handling processes in the clearinghouses 2 that are designed to operate within the stringent time and security demands of immediate payment and delivery. By contrast, conventional e-stores use an offline fulfillment model, that is, the online order is accepted for processing while back office processes fill the order, complete any required funds transfer (e.g. credit card transaction capture) and generate a confirmation. The system 100 of the present invention enables related capabilities with added benefits such as the ability to accept foreign (i.e., with respect to the software publisher) serial numbers as proof-of-purchase of an OEM bundled product and associate or dispense a publisher product serial number in exchange. With this system 100, the OEM need only manage their own serial numbers. The system 100 maintains a cross-reference table of OEM serial numbers to software publisher serial numbers so that an OEM serial number can be transparently recognized as equivalent to one of the publisher's own. The user does not have to deal with more than one serial number, and the software publisher does not have to create a special software build that omits the integration of licensing and protection in order to sell through the OEM. The tracking of OEM sales can remain within the publisher's licensing system and accrue all the benefits thereof.

Another related capability of the license distribution system 100 of the present invention is that of granting discounts based on previous purchases or discount coupons. Upon submitting a serial number for a qualifying product, the system 100 can apply a discount to the current transaction, while preserving any and all channel relationships relevant to that transaction through the association of the new purchase with the serial number of the previous purchase. In a similar manner, discount coupons can be distributed that enable the same benefits. A discount coupon is simply a serial number that is known to the system 100, but is not otherwise associated with a product or license. The coupon represents a virtual product that is associated in the system 100 with another product for the purpose of qualifying a discount. It should be noted that this can be accomplished with very little additional effort on the part of the publisher, and the discount is available immediately after purchasing the qualifying product.

Combined with the foreign serial number support, discounting allows the software publisher to distribute a scaled-down version of their product through an OEM, for example, and offer a discount, based on the OEM serial number, for the full product. Alternatively, discount serial numbers can also be issued as e-coupons granting the bearer access to a particular discount. The system 100 allows this to be accomplished while still maintaining a single software build and no further distribution to the end user. This is accomplished in the system 100 by associating the qualifying product or e-coupon virtual product with the product to be discounted and a discount rate particular to this relationship. As serial numbers belonging to the qualifying product are presented by users, the appropriate discount is applied and an association between the serial number of the qualifying product and that of the discounted product is recorded within the system 100.

In the license distribution system 100 of present invention, the serial number is an item of value, and represents the proof-of-purchase for a particular license or product. Serial numbers can be created using a variety of generation methods, which include manual uploading of externally generated serial numbers and automatic on-the-fly generation. For example, a content provider can import serial numbers generated externally. Alternatively, publisher supplied generation modules can be incorporated. Serial numbers can be generated on-demand, and in a format that is proprietary to the system 100. For example, the format can be cryptographically random and include secure support for flags and binary data that can be individually defined for each distribution channel. A primary use for this data is to enable compatibility with legacy requirements, special needs, and to direct activation behavior.

Serial numbers can be stored in separate inventories in the database 20. A third-party (e.g. OEM) serial number can be associated with a publisher serial number to permit continued protection and tracking of bundled products. The afore-mentioned proprietary format supports publisher-specified payload data to convey data to the software product post-build and pre-activation. Serial-numbers are dispensed to various interfaces including an online purchase component, a reseller component, and a secure serial number vending interface.

In addition, serial numbers can be neutral to the license distribution system 100 or can incorporate information about the product, market, publisher, channel, customer or other relevant data. Partners such as OEMs, distributors or other resellers can gain convenient, secure access to a publisher's serial numbers via the clearinghouse database 20. Internal needs such as sales departments and boxed product manufacturing (which may in itself be outsourced) are also accommodated by the system 100. Publishers can deliver serial numbers securely and transparently with full auditing, verification and invalidation regardless of how they created the original number.

The license distribution system 100 facilitates channel partner and customer buy-in because it provides outward simplicity that reduces barriers for software and digital content providers, who want to implement solutions for managing licenses and increasing revenues without adding to their workload. In the software business, revenue recognition is a difficult problem. The system 100 provides a solution to this long-standing business problem by creating a guaranteed reporting mechanism for product installation by an end user. This reporting mechanism can then be used to validate revenue recognition. The simple and effective system 100 not only reports the install, but it also tracks the sale of content through a multi-channel support system.

Since the system 100 integrates license and registration activation management in a simple end-to-end solution, it facilitates revenue recognition for software publishers. For software publishers to recognize revenue, they often require confirmation that the product has been installed by the end user. The activation process 32 ensures that the software publisher receives this information regardless of the complexities of the distribution channel.

The system 100 allows publishers 2 to track activity throughout the channel right to the end user 8. Customized reports on activation activity in the channel can be created, including information such as serial numbers purchased and remaining, number of activations completed, and activation-limitation overrides. Additional end user information can be gathered as required.

The clearinghouse 2 of the system 100 supports valuable traditional sales channels. Using the system 100, software and digital content providers 4 can distribute products through existing channels, preserving all the benefits of existing relationships and purchasing habits. The clearinghouse 2 allows content providers 4 to define multi-tier distribution channels according to their own particular business needs for partner administration. Each partner-type can be associated with different price structures, terms of payment and system permissions.

Rather than buying physical media such as a CD with content, channel partners need only purchase serial numbers from content providers. For product administration within the license distribution system 100, each serial number is associated with a license for a specific product or product bundle (i.e., depending on how products are marketed) that can be delivered not only through physical media but also by ESD or other electronic method. Channel partners eventually sell these serial numbers to end users 8 who require this information to register and install the software. Content providers 4 can distribute the same product in different ways by defining various bulk packages of serial numbers, each with their own price and activation limits.

Many companies use third-party asset management products, and the system 100 of the present invention can provide the link between these products and individual licenses. This creates value for system administrators charged with ensuring the license compliance of a large number of end users. While each protected product in the system 100 has its own license and is separately registered, third-party asset management products can independently query all licenses that are installed on a particular computer.

Another advantage of the license distribution system 100 is its ability to involve, equip and satisfy the interests of vested parties such as channel partners. Making purchasing easy requires much more than a pay button. The system 100 is designed to facilitate and track license transactions. Channel partners can be kept as informed and as involved in the sales and support process as the software/content publisher requires. The system 100 works with multiple and complex business models simultaneously to satisfy a myriad of user needs and business requirements.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A method for distributing digital licenses comprising the steps of:
creating a new license;
storing said license in a license database at a license clearinghouse along with a plurality of licenses already stored in said license database;
making at least a subset of said licenses in said license database available for browsing, selection and acquisition by license demand chain entities;
distributing said licenses to said license demand chain entities; and
activating said licenses in response to requests from said license demand chain entities.

2. A method as claimed in claim 1, wherein said license demand chain entities comprises at least two of a content provider, a distributor and an end user, said content provider being operable to provides licenses for acquisition by said distributor and said end user, said distributor being operable to acquire licenses, optionally modify licenses and offer said licenses acquired and optionally modified by said distributor to other said license demand chain entities, and said end user being operable to acquire licenses from said distributor and said content provider.

3. A method as claimed in claim 1, further comprising the step of collecting and storing data in said license database relating to usage of said licenses by selected said license demand chain entities, status of selected said licenses, activity associated with selected said licenses comprising at least one of acquisitions, purchases, registrations, activations, downloads and installations, license distribution chain usage, licenses abuses, and sales.

4. A method as claimed in claim 3, further comprising the steps of:
receiving queries from said license demand chain entities;
processing said queries by accessing said license database to obtain selected information stored therein; and
outputting said selected information in response to said queries.

5. A method as claimed in claim 1, further comprising the step of:
maintaining respective license inventories in said license database corresponding to different license demand chain entities.

6. A method as claimed in claim 5, wherein at least one of a distributor and a content provider can mark selected ones of said licenses in their corresponding license inventories for browsing and acquisition.

7. A method as claimed in claim 6, further comprising the steps of:
collecting and storing data in said license database relating to the status of selected said license inventories, usage of said licenses by selected said license demand chain entities, status of selected said licenses, activity associated with selected said licenses comprising at least one of acquisitions, purchases, registrations, activations, downloads and installations, customized report information, license distribution chain usage, licenses abuses, and sales.
receiving queries from said license demand chain entities;
processing said queries by accessing said license database to obtain selected information stored therein; and
outputting said selected information in response to said queries.

8. A method as claimed in claim 1, further comprising the steps of:
receiving a request from an end users to download selected licenses from the clearinghouse;
locating corresponding license information in the database in response to said request;
generating a downloadable license package; and
optionally encrypting said license package.

9. A method as claimed in claim 8, wherein said license package is encrypted using at least one of said end user's public key and signing with said end user's private key.

10. A method as claimed in claim 8, further comprising the steps of:
downloading said license package by said end user;
verifying the clearinghouse signature in said package;
decrypting said license package if encrypted; and
installing said licenses.

11. A method as claimed in claim 10, wherein said licenses are installed in a license server.

12. A method as claimed in claim 10, further comprising the step of activating all of said licenses in said license package with a single activation code.

13. A method as claimed in claim 1, wherein said creating step comprises the step of selecting, by at least one of a content provider and a distributor, whether said activating step comprises activation only for authentication, activation with mandatory registration for authentication, or activation with optional registration for authentication, end users not being required to supply any personal information associated with said registration to activate a license if activation-only is selected.

14. A method as claimed in claim 13, further comprising the step of modifying the selection of said activation-only, said activation with mandatory registration, or said activation with optional registration, for authentication after creation and offering of said license for acquisition.

15. A method as claimed in claim 1, wherein licensed content associated with said license comprises software code, and said creating step comprises the steps of:
defining different license terms for respective data elements in said software code that are critical to the operation of said software code;
offering said licensed content for acquisition in a format that allows searching for installed licenses and acquisition of selected licenses therein for decryption of the corresponding said data elements.

16. A method as claimed in claim 1, wherein said creating step comprises the steps of:
associating a serial number with at least one of said license, and a license bundle having said license and other licenses; and
storing said serial number in said license database.

17. A method as claimed in claim 16, wherein serial numbers corresponding to licenses are stored in said database, said creating step comprises the steps of:
obtaining said serial numbers from said license database that correspond to selected said licenses; and
bundling said serial numbers of the selected said licenses to create a new product.

18. A method as claimed in claim 16, wherein said storing step comprises the step of storing said serial numbers of said licenses of respective said license demand chain entities in separate license inventories.

19. A method as claimed in claim 18, further comprising the step of allowing said serial number in said license inventories to be browsed.

20. A method as claimed in 16, wherein said creating step further comprises the steps of:
offering at least one type of discount with said serial number; and
storing discount information in said license database.

21. A method as claimed in claim 20, wherein said discount information comprises e-coupons to be supplied to one of an end user of a distributor via said license clearinghouse when activation is requested using said serial number.

22. A method as claimed in claim 16, wherein said creating step further comprises the steps of:
obtaining a second serial number that is to be cross-referenced to said serial number; and
storing said second serial number in said license database.

23. A method as claimed in claim 16, wherein said activating step further comprises the step of allowing a license demand chain entity to commence activation regardless of which of said serial number and said second serial number is provided.

24. A method as claimed in claim 16, wherein said serial number is generated via at least one of a plurality of methods comprising manual uploading of externally generated serial numbers, automatic on-the-fly generation, importation by a content provided of serial numbers generated externally thereto, via a publisher-supplied generation modules, in a proprietary format, and said second serial number is obtained from one of a third party and a manufacturer.

25. A method as claimed in claim 24, wherein said proprietary format is cryptographically random.

26. A method as claimed in claim 24, wherein said proprietary format supports at least one of flags and binary data that are individually defined for respective distribution channels for said license.

27. A method as claimed in claim 16, further comprising the step of collecting and storing in said license database data relating to the use of said serial numbers during activations and sales of said license among different distribution channels employed by said license demand chain entities.

28. A method for creating a license in a digital license distribution system by a content provider, comprising the following steps:
authenticating the content provider with a license clearinghouse;
generating a new product identifier at the clearinghouse upon a request by the content provider to create a new license;
receiving at least one of distribution rules and data, and license terms from the content provider by the license clearinghouse;
providing content access control data from the content provider to the license clearinghouse;
encrypting the content access control data by the clearinghouse with a license key of the content provider;
digitally signing a license body by the content provider at the license clearinghouse, the license body comprising at least said distribution rules and data, said license terms, and said encrypted content access control data;
generating a license identifier for the license by the license clearinghouse;
attaching the content provider's digital certificate to the license comprising said license identifies and license body; and
storing the license in a license database at the license clearinghouse.

29. A method as claimed in claim 28, wherein said license terms comprise a tolerance term indicating that said license can be activated a first number of times, the license clearinghouse being operable to decrement a counter each time the license is activated and to disable the license when said first number of times for activation is exceeded.

30. A method as claimed in claim 29, further comprising the step of modifying said tolerance term to allow additional activations of the license.

31. A method as claimed in claim 29, wherein an end user has activated said license said first number of times, and further comprising the steps of:
receiving a request from said end user for additional activations of the license;
querying the license database to activate a record of activations stored therein; and
modifying the license to allow additional activations and storing data relating to said modifying in said license database if the end user does not appear from said record to have misused the license.

32. A method as claimed in claim 28, further comprising the step of receiving at least one of extended distribution rules and data and extended license terms, which extend the period during which the license can be activated, from the content provider by the license clearinghouse to create a renewal/upgrade digital license corresponding to one of the existing licenses in said license database.

33. A method as claimed in claim 28, further comprising the steps of:
downloading the licenses a license pack from the clearinghouse to a local license store at the content provider; and
distributing the licenses with the associated content on a content distribution network by the content provider.

34. A method for authenticating and activating a license in a digital license distribution system by an end user comprising the steps of:
receiving a license for licensed content from a content provider or distributor;
installing the license in a license store at the end user;
generating an installation code comprising a user identifier corresponding to the processing device employed by the end user in said installing step;
transmitting a license identifier provided in the license and said installation code to a license clearinghouse;
receiving an activation code from the license clearinghouse, the license clearinghouse using said license identifier to locate a license key stored therein and to generate said activation code using said license key and said user identifier;
installing said activation code from the license clearinghouse; and
decrypting an encrypted portion of the license using the installed activation code.

35. A method as claimed in claim 34, wherein the end user processing device comprises a license compliance module operable to grant access to said licensed content after determining that the license is installed and valid.

36. A method as claimed in claim 34, wherein said licensed content is distributed via a network selected from the group consisting of a distribution network that distributes both the license and said licensed content, and a content distribution network that is separate from a license distribution network used to distribute the license.

37. A method as claimed in claim 34, wherein said user identifier in said generating step is not obtained until after said installing step has commenced.

38. A method for activating a license in a digital license distribution system by a license clearinghouse comprising the steps of:
receiving a license identifier and an installation code from an end user, said installation code comprising a user identifier corresponding to the processing device employed by the end user to install the license and generated when said activating is commenced by the end user;
obtaining a license key based on the license identifier from a license database in the license clearinghouse;
generating an activation code using said license key and said user identifier; and
transmitting the activation code to the end user.

39. A method as claimed in claim 38, further comprising the steps of:
defining activation to be valid only during a selected time period;
storing data relating to said time period in said license database; and
disabling the license from activation when said time period has expired.

40. An apparatus for distributing digital licenses in a network comprising:
at least one license clearinghouse configured to communicate via said network with at least two of a group of license demand chain entities comprising a content provider, a distributor, and an end user, said content provider providing licenses for acquisition by said distributor and said end user, said distributor acquiring licenses, optionally modifying licenses and offering said licenses acquired and optionally modified by said distributor to other said license demand chain entities, and said end user acquiring licenses from said distributor and said content provider;
wherein said license clearinghouse comprises a license database and a plurality of modules for enabling said license demand chain entities connected thereto via said network to perform operations, said license database being configured to store said licenses associated with different license demand chain entities in respective license inventories, said plurality of modules comprising a license generation module, a license inventory module, a user authentication module and an activation module, said license generation module being configured to allow said content provider to create new said licenses and said distributor to modify acquired said licenses, and to create license identifiers and keys for activating said licenses which are stored in said license database, said license inventory module being configured to allow said content provider, said distributor and said end user to manage said licenses stored in their corresponding license inventories and to browse the corresponding license inventories of other said license demand chain entities, said authentication module being configured to identify said clearinghouse and said license demand chain entities to each other, and said activation module being configured to conduct activation transactions to activate licenses in response to activation requests from said distributor and said end user.

41. An apparatus for distributing digital licenses as claimed in claim 40, wherein at least one of said licenses comprises:
a license identifier;
a set of distribution rules and data;
a set of license terms;
an encrypted data portion that contains content access control information;
a digital signature corresponding to said content provider; and
a digital certificate for said content provider.

42. An apparatus for distributing digital licenses as claimed in claim 41, wherein said license comprises a plurality of license identifiers corresponding to the same license body, said license body comprising said set of distribution rules and data, said set of license terms, said encrypted data portion that contains content access control information, said digital signature corresponding to said content provider, and said digital certificate for said content provider, said license database being programmable to store said plurality of license identifiers separately from said license body.

43. An apparatus for distributing digital licenses as claimed in claim 41, wherein said license further comprises a product identifier.

44. An apparatus for distributing digital licenses as claimed in claim 41, wherein said license is extended by changing at least one of said distribution rules and data and said set of license terms, said extended license comprising:
at least one of an extended set of distribution rules and data, and an extended set of license terms;
a digital signature corresponding to said license demand chain entity that created said extended license; and
a digital certificate of said license demand chain entity that created said extended license.

45. An apparatus for distributing digital licenses as claimed in claim 44, wherein said extended license further comprises the original license body comprising said set of distribution rules and data; said set of license terms; said encrypted data portion that contains content access control information; said digital signature corresponding to said content provider, and said digital certificate for said content provider.

46. An apparatus for distributing digital licenses as claimed in claim 41, wherein a digital license pack comprises:
a license pack identifier;
a list of one or more license identifiers corresponding to respective said licenses selected to create said license pack;
a license body comprising said set of distribution rules and data, said set of license terms, and said encrypted data of each of said licenses;
a digital signature corresponding to one of said content provider and distributor who created said license pack; and
a digital certificate of said one of said content provider and said distributor.

47. An apparatus for distributing digital licenses as claimed in claim 40, wherein said plurality of modules further comprises a report generation module configured to process queries from said license demand chain entities by accessing said license database to obtain selected information stored therein and outputting said selected information in response to said queries.

48. An apparatus for distributing digital licenses as claimed in claim 47, wherein said selected information comprises at least one of the status of selected said license inventories, usage of said licenses by selected said license demand chain entities, status of selected said licenses, activity associated with selected said licenses comprising at least one of acquisitions, purchases, registrations, activations, downloads and installations, customized report information, license distribution chain usage, licenses abuses, and sales.

49. An apparatus for distributing digital licenses as claimed in claim 40, wherein said plurality of modules further comprises a license download module configured to, facilitate downloading of different types of license products available from said license clearinghouse by said license demand chain entities, and to generate license packs from information available from said license database.

50. An apparatus for distributing digital licenses as claimed in claim 40, wherein said plurality of modules further comprises a communications module configured to allow said license clearinghouse to communicate with at least one other license clearinghouse via said network.

51. An apparatus for distributing digital licenses as claimed in claim 50, wherein said other license clearinghouse comprises a license database for storing licenses associated with license demand chain entities connected thereto, said license clearinghouse and said other license clearinghouse being operable to share information stored in each corresponding said license database.

52. An apparatus for distributing digital licenses as claimed in claim 40, wherein said plurality of modules further comprises a third-party processor module configured to allow said license clearinghouse to interact with third party processors.

53. An apparatus for distributing digital licenses as claimed in claim 52, wherein at least one of said third party processors is a payment processor for handling financial transactions associated with the purchase of said licenses.

54. An apparatus for distributing digital licenses as claimed in claim 40, wherein said license demand chain entities comprises at least said distributor, further comprising a management client and a license store provided at said distributor and configured to allow said distributor to perform at least one of a plurality of operations comprising registering with said license clearinghouse via said user authentication module, authenticating with said license clearinghouse via said user authentication module, modifying digital licenses via said license generation module, browsing said license inventories of other said license demand chain entities via said license inventory module, acquiring said licenses from said content provider and another said distributor via said license inventory module, providing licenses for acquisition by another said distributor and said end user via said license inventory module, and activating said licenses via said license activation module.

55. An apparatus for distributing digital licenses as claimed in claim 54, wherein said plurality of modules comprises at least one of a report generation module and a license download module, said report generation module being configured to process queries from said license demand chain entities by accessing said license database to obtain selected information stored therein and outputting said selected information in response to said queries, said selected information comprising at least one of status of selected said license inventories, usage of said licenses by selected said license demand chain entities, status of selected said licenses, activity associated with selected said licenses comprising at least one of acquisitions, purchases, registrations, activations, downloads and installations, customized report information, license distribution chain usage, licenses abuses, and sales, said license download module being configured to facilitate downloading of different types of license products available from said license clearinghouse by said license demand chain entities, and to generate license packs from information available from said license database, and said management client and said license store being configured to allow said distributor to generate reports via said report generation module, and to download license packs via said license download module.

56. An apparatus for distributing digital licenses as claimed in claim 40, wherein said license demand chain entities comprises at least said content provider, further comprising a management client and a license store provided at said content provider and configured to allow said content provider to register with said license clearinghouse via said user authentication module, authenticate with said license clearinghouse via said user authentication module, create new said licenses via said license generation module, provide said licenses for acquisition by said distributor and said end user via said license inventory module, and activate said licenses via said license activation module.

57. An apparatus for distributing digital licenses as claimed in claim 56, wherein said plurality of modules comprises report generation module and a license download module, said report generation module being configured to process queries from said license demand chain entities by accessing said license database to obtain selected information stored therein and outputting said selected information in response to said queries, said selected information comprising at least one of status of selected said license inventories, usage of said licenses by selected said license demand chain entities, status of selected said licenses, activity associated with selected said licenses comprising at least one of acquisitions, purchases, registrations, activations, downloads and installations, customized report information, license distribution chain usage, licenses abuses, and sales, said license download module being configured to facilitate downloading of different types of license products available from said license clearinghouse by said license demand chain entities, and to generate license packs from information available from said license database, and said management client and said license store being configured to allow said content provider to generate reports via said report generation module, and to generate license packs via said license download module.

58. An apparatus for distributing digital licenses as claimed in claim 40, wherein said license demand chain entities comprises at least said end user, further comprising a management client and a license store provided at said end user and configured to allow said end user to register with said license clearinghouse via said user authentication module, authenticate with said license clearinghouse via said user authentication module, to browse said license inventories of other said license demand chain entities via said license inventory module, to acquire licenses from said content provider and said distributor via said license inventory module, and to activate licenses via said license activation module.

59. An apparatus for distributing digital licenses as claimed in claim 40, wherein said license demand chain entities each comprise:
a management client and a license store configured to allow registration with said license clearinghouse via said user authentication module, authentication with said license clearinghouse via said user authentication module, creation of new said licenses by said content provider via said license generation module, browsing, selection and acquisition of said licenses by said distributor and said end user via said license inventory module, and activation of licenses via said license activation module; and
a license compliance module configured to use said licenses in said license store to control access to corresponding licensed content.

60. An apparatus for distributing digital licenses as claimed in claim 59, wherein said license compliance module is a license server that manages licenses for multiple internal client computers.

61. An apparatus for distributing digital licenses, the digital licenses and related information being maintained in a digital license clearinghouse, the apparatus comprising:
a license store at a content provider; and
a license management client at said content provider adapted to register with and authenticate said content provider to said license clearinghouse, create digital licenses and store them at said license clearinghouse, and designate a plurality of said digital licenses for acquisition by distributors and end users via a license inventory service at said license clearinghouse, said license inventory service being operable to maintain respective license inventories for license demand chain entities connected to said license clearinghouse via a network.

62. An apparatus are claimed in claim 61, said license management client further adapted to generate reports using said license database.

63. An apparatus for distributing digital licenses, the digital licenses and related information being maintained in a digital license clearinghouse, the apparatus comprising:
a license store at a distributor; and
a license management client at said distributor adapted to register with and authenticate itself to said license clearinghouse, designate a plurality of said digital licenses for acquisition by other distributors and end users via a license inventory service at said license clearinghouse, said license inventory service being operable to maintain respective license inventories for license demand chain entities connected to said license clearinghouse via a network, acquire a plurality of digital license types from a content provider or other distributor, modify and optionally extend the acquired plurality of digital license types via the license generation service of the first license clearinghouse, provide the acquired, modified and optionally extended acquired plurality of digital license types for acquisition by distributors and end users via a license inventory service of the first license clearinghouse, said license inventory service being operable to maintain respective license inventories for license demand chain entities connected to said license clearinghouse via a network.

64. An apparatus are claimed in claim 63, said license management client further adapted to perform at least one of a plurality of operations comprising browse said license inventories of other license demand chain entities to select licenses therefrom for acquisition, generate reports via said first license clearinghouse, download the acquired, modified and optionally extended plurality of digital license types via the license download service of said license clearinghouse, activate the acquired, modified and optionally extended plurality of digital license types via said first license clearinghouse.

65. An apparatus for distributing digital licenses, the digital licenses and related information being maintained in a digital license clearinghouse, the apparatus comprising:
a license store at an end user;
a license compliance module at an end user adapted to register with and authenticate itself to said license clearinghouse, acquire a plurality of license types from content providers and distributors via said license clearinghouse.

66. An apparatus are claimed in claim 65, said license management client further adapted to perform at least one of a plurality of operations comprising browse said license inventories of other license demand chain entities to select licenses therefrom for acquisition, obtain reports via said license clearinghouse, download the plurality of license types via said license clearinghouse, and activate the plurality of license types via said license clearinghouse.

67. The end user according to claim 65, wherein said license compliance module is a license server that manages licenses for multiple internal client computers.

68. An apparatus for distributing licenses in a network comprising at least one content provider and at least one of a distributor and an end user, said system comprising:
at least one license clearinghouse comprising a license database, a license generation module being configured to allow said content provider to create new said licenses, and at least one interface module configured to allow said at least one of a distributor and an end user to connect directly to said license clearinghouse, said license clearinghouse being configured to allow said at least one of a distributor and an end user to access said license database to browse and select from a plurality of licenses stored therein and to acquire selected said licenses;
wherein at least one of said licenses comprises a license identifier, a product identifier, distribution rules and data, license terms, an encrypted data portion that contains content access control information, a digital signature corresponding to said content provider, and a digital certificate for said content provider.

69. An apparatus for distributing licenses as claimed in claim 68, wherein said license clearinghouse is configured to be accessed by a distributor and to generate an extended license by changing at least one of said distribution rules and data and said license terms in accordance with instructions from said distributor.

70. An apparatus for distributing licenses as claimed in claim 69, wherein said extended license comprises:
an extended license identifier;
the original license body comprising said product identifier, said set of distribution rules and data, said set of license terms, said encrypted data portion that contains content access control information, said digital signature corresponding to said content provider, and said digital certificate for said content provider;
at least one of extended distribution rules and data and extended license terms that change at least one of said distribution rules and data and said license terms;
a digital signature corresponding to said distributor that created said extended license; and
a digital certificate of said distributor.

71. An apparatus for distributing licenses as claimed in claim 70, wherein an extended digital license pack comprises:
an extended license pack identifier;
a plurality of said extended digital license identifiers;
the original license body of each of said licenses selected to create said extended license pack comprising, respectively, said product identifier, said distribution rules and data, said license terms, said encrypted data portion that contains content access control information, said digital signature corresponding to said content provider, and said digital certificate for said content provider;
at least one of extended distribution rules and data and extended license terms that change at least one of said distribution rules and data and said license terms;
a digital signature of a distributor that created the extended digital license; and
a digital certificate of said distributor.

72. An apparatus for distributing licenses as claimed in claim 68, wherein a digital license pack comprises:
a license pack identifier;
a list of one or more license identifiers corresponding to said licenses selected to create said license pack;
the original license body of each of said licenses selected to create said license pack comprising, respectively, said product identifier, said distribution rules and data, said license terms, said encrypted data portion that contains content access control information, said digital signature corresponding to said content provider, and said digital certificate for said content provider;
a digital signature corresponding to one of said content provider and distributor who created said license pack; and
a digital certificate of said one of said content provider and said distributor.

73. An apparatus for distributing licenses as claimed in claim 68, wherein a renewal/upgrade digital license comprises:
a renewal/upgrade license identifier; and
a renewal/upgrade digital license body comprising the original said license identifier and said product identifier, renewal/upgrade distribution rules and data to extend the duration of the license corresponding to said license identifier, encrypted data comprising content access information, said digital signature of said content provider, and said digital certificate of said content provider.

74. An apparatus for distributing licenses as claimed in claim 73, wherein said encrypted data is encrypted with a license key generated by said license clearinghouse and stored in said license database.

75. An apparatus for distributing licenses as claimed in claim 73, wherein said content access information comprises data that is required to execute software or access digital content that is being licensed.

76. An apparatus for distributing licenses as claimed in claim 73, wherein a renewal/upgrade digital license pack comprises:
a renewal/upgrade license pack identifier;
a plurality of original renewal/upgrade license identifiers;
the original license body of each of said licenses selected to create said renewal/upgrade digital license pack comprising, respectively, said product identifier, said distribution rules and data, said license terms, said encrypted data portion that contains content access control information, said digital signature corresponding to said content provider, and said digital certificate for said content provider;
said digital signature of said content provider, and
said digital certificate of said content provider.

77. An apparatus for distributing licenses as claimed in claim 73, wherein an extended renewal/upgrade digital license comprises:
an extended renewal/upgrade license identifier; and
an extended renewal/upgrade digital license body comprising said renewal/upgrade digital license, and at least one of extended distribution rules and data and extended license terms than modify any of said distribution rules and data and said license terms in the original said license;
a digital signature of a distributor that created the extended renewal/upgrade digital license; and
a digital certificate of the distributor that created the extended renewal/upgrade digital license.

78. An apparatus for distributing licenses as claimed in claim 77, wherein an extended renewal/upgrade digital license pack comprises:
an extended renewal/upgrade license pack identifier; and
a plurality of said extended renewal/upgrade license identifiers;
said extended renewal/upgrade digital license body of each of said extended renewal/upgrade licenses selected to create said extended renewal/upgrade digital license pack;
a digital signature of a distributor that created the extended renewal/upgrade digital license pack; and
a digital certificate of said distributor that created the extended renewal/upgrade digital license pack.

79. A method for distributing digital licenses comprising the steps of:
defining user rights to licensed content upon attainment of a valid license, said user rights to be controlled on a basis selected from the group consisting of a content feature-specific basis, an application-specific basis, a release-specific basis, a distribution channel-specific basis, and a user-specific basis, said licensed content being configured to operate sub-optimally upon installation by an end user without said license; and
creating said license, said license comprising license terms relating to the selected said basis, and content access information needed to operate said licensed content better than sub-optimally.

80. A method as claimed in claim 79, further comprising the steps of:
storing said license in a license database at a license clearinghouse;
encrypting at least a portion of said license comprising said content access information using a license key;
assigning said license a license identifier; and
storing said license key and said license identifier in said license database.

81. A method as claimed in claim 80, further comprising the steps of:
distributing said license in a de-activated state; and
activating said license in response to a request to activate said license from a license demand chain entity to which said license was distributed.

82. A method as claimed in claim 79, wherein said licensed content is distributed via one of a distribution network that distributes both said license and said licensed content, and a content distribution network that is separate from a license distribution network used to distribute said license.

83. A method as claimed in claim 80, further comprising the steps of:
receiving said license in a de-activated state;
commencing installation of said license by generating an installation code comprising a user identifier corresponding to the processing device employed for said installation;
transmitting said license identifier and said installation code to a license clearinghouse;
receiving an activation code from said license clearinghouse, said license clearinghouse using said license identifier to locate a license key stored therein and to generate said activation code using said license key and said user identifier;
installing said activation code from the license clearinghouse; and
decrypting an encrypted portion of said license using the installed activation code.

84. A method for extending a license in a digital license distribution system by a distributor, comprising the following steps:
authenticating the distributor with a license clearinghouse;
receiving a request to extend the license;
receiving at least one of extended distribution rules and data and extended license terms from the distributor at the license clearinghouse;
digitally signing the extended said license body by the distributor at the license clearinghouse;
attaching the distributor's digital certificate to the license;
generating a license identifier for the license by the license clearinghouse; and
storing the extended license in a license database at the license clearinghouse.

85. A method as claimed in claim 84, wherein the distributor obtains the content from the content provider through a content distribution network;
the distributor downloads licenses in a license pack that correspond to the content from the clearinghouse to their local license store; and
the distributor distributes the licenses with the content on a content distribution network.

86. A method for providing a license to an end user from a content provider in a digital license distribution system, comprising the following steps:
authenticating the content provider with a license clearinghouse;
accessing licenses at the license clearinghouse by the content provider making the licenses available for acquisition, authentication and activation to potential end users at the license clearinghouse;
providing licensed content and the licenses to one or more end users; and
authenticating and activating the license by an end user at the license clearinghouse.

87. A method as claimed in claim 86, further comprising the step of making a payment through a third-party payment processor to the license clearinghouse, the end user being required to complete a payment transaction with the content provider using the third-party payment processor in conjunction with the transfer of ownership of the licenses.

88. A method as claimed in claim 87, further comprising the steps of:
receiving the license and content from the content provider through the content provider's distribution network; and
installing the license on their local license store or on a local license server;

89. A method of a distributor acquiring ownership of digital licenses from a content provider comprising the steps of:
the content provider authenticating with the clearinghouse and making licenses available for acquisition by the distributor via the clearinghouse;
the distributor authenticating with the clearinghouse and requesting ownership of selected ones of the licenses from the content provider;
the content provider transferring ownership of the licenses to the distributor via the clearinghouse;
the distributor modifying the licenses; and
distributing the modified licenses via at least one of a plurality of distribution channels comprising making the modified licenses available via the clearinghouse, and downloading the modified license for distribution by the distributor.

90. The method according to claim 89, wherein the distributor is required to complete a payment transaction with the content provider using a third-party payment processor in conjunction with the transfer of ownership of the licenses.

91. The method of a distributor acquiring ownership of a set of digital licenses from another distributor comprising the steps of:
distributor A authenticating with a clearinghouse and making licenses available for acquisition by distributor B via the clearinghouse;
distributor B authenticating with the clearinghouse and requesting ownership of selected ones of the licenses from distributor A;
distributor A transferring ownership of the licenses to distributor B via the clearinghouse;
the distributor modifying the licenses; and
distributing the modified licenses via at least one of a plurality of distribution channels comprising making the modified licenses available via the clearinghouse and downloading the modified license for distribution by the distributor.

92. The method according to claim 91, wherein distributor B is required to complete a payment transaction with distributor A using a third-party payment processor in conjunction with the transfer of ownership of the licenses.

93. A method of an end user acquiring ownership of a set of digital licenses from a distributor comprising the steps of:
the distributor authenticating with the clearinghouse and making the licenses available for acquisition by end users via the clearinghouse;
the end user obtaining the content from a distribution network;
the end user authenticating with the clearinghouse and requesting ownership of the corresponding licenses from the distributor;
the distributor transferring ownership of the licenses-to the end user via the clearinghouse; and
the end user activating the licenses via the clearinghouse to access the content.

94. The method according to claim 93, wherein the end user is required to complete a payment transaction with the distributor using a third-party payment processor in conjunction with the transfer of ownership of the licenses.

95. A method of an end user acquiring ownership of upgrade/renewal digital licenses from a content provider or a distributor comprising the steps of:
the content provider or distributor authenticating with the clearinghouse and making the upgrade/renewal licenses available for acquisition by end users via the clearinghouse;
the end user authenticating with the clearinghouse and browsing content provider or distributor license inventories for upgrade or renewal licenses;
the end user downloading selected licenses in the form of a license pack from the clearinghouse to one of a local license store and a local license server;
the end user requesting ownership of the licenses from the content provider or distributor via the clearinghouse;
the content provider or distributor transferring ownership of the licenses to the end user via the clearinghouse; and
the end user activating the licenses via the clearinghouse to access the content.

96. The method according to claim 95, wherein the end user is required to complete a payment transaction with the content provider or distributor using a third-party payment processor in conjunction with the transfer of ownership of the upgrade/renewal licenses.

97. The method according to claim 95, wherein the end user activating step comprises the steps of:
a compliance module on the end user's computing device generating an installation code that contains a license identifier information and information specific to the end user's computing device;
transmitting the license identifier and installation code from the end user to the clearinghouse;
the clearinghouse looking up the license identifier in a license database to obtain a license key;
generating a unique activation code for the end user's device using information from the license key and the installation code;
transmitting the activation code from the clearinghouse to the end user;
the license compliance module accepting the activation code and using the embedded license key to decrypt the an encrypted portion of the license; and
using the decrypted portion of the license, which contains content access control information, to allow the end user to access to previously inaccessible portions of the content.

98. The method according to claim 97, wherein the end user authenticates with the clearinghouse prior to transmitting the license identifier and installation code.

99. The method according to claim 97, wherein a license pack identifier is used instead of the license identifier to activate all of the licenses in a license pack.

100. The method according to claim 95, wherein an end user activates a digital license via a proxy content provider, proxy distributor, or proxy end user, the method comprising the steps of:
a compliance module on the end user's computing device generating an installation code that contains a license identifier and information specific to the end user's computing device;
transmitting the license identifier and installation code from the end user to one of a proxy content provider, proxy distributor, or proxy end user;
the proxy content provider, proxy distributor, or proxy end user transmitting the license identifier and installation code to the clearinghouse;
the clearinghouse looking up the license identifier in the database to obtain a license key;
generating a unique activation code using information from the license key and the installation code;
transmitting the activation code from the clearinghouse to the proxy content provider, proxy distributor, or proxy end user;
transmitting the activation code from the proxy content provider, proxy distributor, or proxy end user back to the end user;
the license compliance module accepting the activation code and using the embedded license key to decrypt the an encrypted portion of the license; and
using the decrypted portion of the license, which contains content access control information, to allow the end user to access to previously inaccessible portions of the content.

101. The method according to claim 100, wherein the proxy content provider, distributor, or end user authenticates with the clearinghouse prior to transmitting the license identifier and installation code.

102. The method according to claim 100, wherein a license pack identifier is used instead of the license identifier to activate all of the licenses in a license pack.
